(19) United States
(12) Patent Application Publication
(10) Pub. No.: US 2026/0230235 A1
(43) Pub. Date: Aug. 6, 2026

(54) APPARATUSES AND METHODS FOR RETRANSMISSIONS USING CROSS-TRANSPORT BLOCK CHECK BLOCKS

(71) Applicant: Huawei Technologies Co., Ltd., Shenzhen (CN)

(72) Inventors: Yu Cao, Kanata (CA); Huazi Zhang, Zhejiang (CN); Xiaoyan Bi, Ottawa (CA); Jianglei Ma, Ottawa (CA)

(21) Appl. No.: 19/636,705

(22) Filed: Apr. 1, 2026

Related U.S. Application Data
(63) Continuation of application No. PCT/CN2023/123093, filed on Oct. 4, 2023.

(51) Int. Cl. H04L 1/1812; H04L 1/00

(52) U.S. Cl. CPC H04L 1/1816; H04L 1/0057

(57) ABSTRACT

Methods and apparatuses for retransmissions using cross-block check blocks are described. The cross-block check blocks may be generated using code blocks selected from across two or more transport blocks. A transmitter node transmits an initial transmission of a first data block having a first plurality of code blocks, and a second data block having another plurality of code blocks. The transmitter node transmits a retransmission that includes at least one cross-block check block from a first set of cross-block check blocks generated using a first partition of code blocks from the first data block and a first partition of code blocks from the second data block. The retransmission also includes at least one cross-block check block from a second set of cross-block check blocks generated using a second partition of code blocks from the first data block and a second partition of code blocks from the second data block.

### CROSS-REFERENCE TO RELATED APPLICATION

This application is a continuation of International Patent Application PCT/CN2023/123093, filed on Oct. 4, 2023, which is incorporated by reference in its entirety.

### TECHNICAL FIELD

The present disclosure relates to methods and apparatuses for wireless communications using a retransmission scheme, including retransmission schemes using cross-block check blocks, which may be generated from code blocks selected from across a plurality of transport blocks.

### BACKGROUND

Hybrid automatic repeat request (HARQ) is a retransmission scheme that is used in many applications in wireless communications. In conventional HARQ, a retransmission is performed by a transmitter node if an initial transmission to a receiver node fails or if the initial transmission is not successfully decoded by the receiver node. In the long-term evolution (LTE) standard, a transport block (TB) may be divided by the transmitter node into multiple forward error correction (FEC)-encoded blocks. However, conventional HARQ retransmission is TB-based. This means that even if only one transmission of a FEC-encoded block of the TB fails (e.g., the receiver node fails to successfully decode even one FEC-encoded block), the redundant versions of all FEC-encoded blocks need to be retransmitted. This may not be an efficient use of communication resources.

Accordingly, it would be useful to provide solutions for performing transmissions using an improved retransmission scheme.

### SUMMARY

In various examples, the present disclosure describes methods and apparatuses for wireless communications using a retransmission scheme that may help to reduce the use of communication resources (e.g., bandwidth, etc.) compared to some conventional retransmission schemes. Examples of the present disclosure may enable practical implementation of retransmissions using cross-block check blocks, or more specifically cross-TB check blocks (which are cross-block check blocks generated using code blocks selected from across multiple TBs). Retransmissions using cross-TB check blocks may enable one retransmission to provide information to assist in decoding of multiple TBs, which may allow for more efficient use of communication resources.

Examples of the present disclosure may be applicable to various types of wireless communications, including unicast, multicast, groupcast and/or broadcast applications.

In some examples, a retransmission scheme is described in which cross-block check blocks may be generated using a partition of code blocks selected from across multiple data blocks (which may be multiple TBs). This may help to reduce the decoding complexity at the receiver node.

In some examples, signaling schemes are described for indicating a retransmission using cross-TB check blocks. In some examples, a single common HARQ process number may be used to indicate a retransmission using cross-TB check blocks. The common HARQ process number may indicate multiple TBs, and may also be used to indicate a retransmission related to the multiple TBs. Using a common HARQ process number to indicate multiple TBs may be relatively simple to implement, with relatively small overhead. In some examples, multiple HARQ process numbers may be used to indicate a retransmission using cross-TB check blocks. Each HARQ process number may indicate a respective TB that is used to generate the cross-TB check blocks. Using multiple HARQ process numbers to indicate a retransmission using cross-TB check blocks may enable greater flexibility.

In an example aspect, the present disclosure describes a method at a transmitter node, the method including: transmitting, to a receiver node, an initial transmission of a first data block having a first plurality of code blocks, and another initial transmission of a second data block having another plurality of code blocks; and transmitting a retransmission to the receiver node, the retransmission including at least one cross-block check block from a first set of cross-block check blocks generated using a first partition of code blocks from the first data block and a first partition of code blocks from the second data block, the retransmission also including at least one cross-block check block from a second set of cross-block check blocks generated using a second partition of code blocks from the first data block and a second partition of code blocks from the second data block.

In an example of the preceding example aspect of the method, each of the first and second data blocks may be partitioned into two or more partitions, each partition having an equal or approximately equal number of code blocks.

In an example of the preceding example aspect of the method, a respective set of cross-block check blocks may be generated by selecting, from each of the first and second data blocks, a respective partition of the two or more partitions, and combining code blocks belonging to the selected respective partitions.

In an example of any of the preceding example aspects of the method, the method may include: transmitting another retransmission, the other retransmission including at least one different cross-block check block from the first set of cross-block check blocks and also including at least one different cross-block check block from the second set of cross-block check blocks.

In an example of any of the preceding example aspects of the method, the first and second data blocks may be first and second transport blocks, first and second code block groups, or first and second packets.

In an example of any of the preceding example aspects of the method, the method may include: transmitting or receiving control information for the retransmission, the control information including information about partitioning of the code blocks in each of the first and second data blocks.

In another example aspect, the present disclosure describes a method at a receiver node, the method including: receiving, from a transmitter node, an initial transmission of a first data block having a first plurality of code blocks to a receiver node, and another initial transmission of a second data block having another plurality of code blocks to the receiver node; and receiving a retransmission from the transmitter node, the retransmission including at least one cross-block check block from a first set of cross-block check blocks generated using a first partition of code blocks from the first data block and a first partition of code blocks from the second data block, the retransmission also including at least one cross-block check block from a second set of cross-block check blocks generated using a second partition of code blocks from the first data block and a second partition of code blocks from the second data block.

In an example of the preceding example aspect of the method, the method may include: performing joint decoding of the first and second data blocks together with the cross-block check blocks received from the retransmission.

In an example of any of the preceding example aspects of the method, the first and second data blocks may be first and second transport blocks, first and second code block groups, or first and second packets.

In an example of any of the preceding example aspects of the method, the method may include: transmitting or receiving control information for the retransmission, the control information including information about partitioning of the code blocks in each of the first and second data blocks.

In another example aspect, the present disclosure describes a method at a transmitter node, the method including: transmitting or receiving control information for an initial transmission of multiple transport blocks to a receiver node, the control information including a common hybrid automatic repeat request (HARQ) process number (HPN) common to the multiple transport blocks; transmitting, to the receiver node, the initial transmission of the multiple transport blocks; transmitting, to the receiver node, further control information for a retransmission, the further control information including the common HPN; and transmitting or receiving a retransmission of one or more cross-block check blocks generated from code blocks selected from across two or more of the multiple transport blocks.

In an example of the preceding example aspect of the method, the control information for the initial transmission may include a respective indicator for each respective transport block indicating a new transmission.

In an example of any of the preceding example aspects of the method, the further control information for the retransmission may also include respective two or more indicators indicating a retransmission for the two or more of the multiple transport blocks.

In an example of the preceding example aspect of the method, the further control information for the retransmission may include an indicator indicating a new initial transmission to be sent with the retransmission, and transmitting the retransmission may include transmitting the new initial transmission.

In an example of a preceding example aspect of the method, the further control information for the retransmission may include indices of the two or more of the multiple transport blocks.

In an example of any of the preceding example aspects of the method, the method may include: receiving, from the receiver node, feedback indicating decoding was unsuccessful for the two or more of the multiple transport blocks.

In an example of a preceding example aspect of the method, the one or more cross-block check blocks may be generated from code blocks selected from across all of the multiple transport blocks.

In an example of any of the preceding example aspects of the method, the retransmission may include at least one cross-block check block from a first set of cross-block check blocks generated using a first partition of code blocks from each of the two or more of the multiple transport blocks, the retransmission may also include at least one cross-block check block from a second set of cross-block check blocks generated using a second partition of code blocks from each of the two or more of the multiple transport blocks.

In another example aspect, the present disclosure describes a method at a receiver node, the method including: transmitting or receiving control information for an initial transmission of multiple transport blocks from a transmitter node, the control information including a common hybrid automatic repeat request (HARQ) process number (HPN) common to the multiple transport blocks; receiving, from the transmitter node, the initial transmission of the multiple transport blocks; receiving, from the transmitter node, further control information for a retransmission, the further control information including the common HPN; and transmitting or receiving a retransmission of one or more cross-block check blocks generated from code blocks selected from across two or more of the multiple transport blocks.

In an example aspect of the preceding example aspect of the method, the control information for the initial transmission may include a respective indicator for each respective transport block indicating a new transmission.

In an example aspect of any of the preceding example aspects of the method, the further control information for the retransmission may also include respective two or more indicators indicating a retransmission for the two or more of the multiple transport blocks.

In an example aspect of the preceding example aspect of the method, the further control information for the retransmission may include an indicator indicating a new transmission to be sent with the retransmission, and receiving the retransmission may include receiving the new initial transmission.

In an example aspect of a preceding example aspect of the method, the further control information for the retransmission may include indices of the two or more of the multiple transport blocks.

In an example aspect of any of the preceding example aspects of the method, the method may include: transmitting, to the transmitter node, feedback indicating decoding was unsuccessful for the two or more of the multiple transport blocks.

In an example aspect of a preceding example aspect of the method, the one or more cross-block check blocks may be generated from code blocks selected from across all of the multiple transport blocks.

In an example aspect of any of the preceding example aspects of the method, the retransmission may include at least one cross-block check block from a first set of cross-block check blocks generated using a first partition of code blocks from each of the two or more of the multiple transport blocks, the retransmission may also include at least one cross-block check block from a second set of cross-block check blocks generated using a second partition of code blocks from each of the two or more of the multiple transport blocks.

In another example aspect, the present disclosure describes a method at a transmitter node, the method including: transmitting or receiving control information for an initial transmission of multiple transport blocks to a receiver node, the control information including a respective hybrid automatic repeat request (HARQ) process number (HPN) for each respective one of the multiple transport blocks; transmitting, to the receiver node, the initial transmission of the multiple transport blocks; transmitting or receiving further control information for a retransmission, the further control information including the respective HPN for each of two or more of the multiple transport blocks; and transmitting, to the receiver node, a retransmission of one or more cross-block check blocks generated from code blocks selected from across the two or more of the multiple transport blocks.

In an example aspect of the preceding example aspect of the method, the method may include: receiving, from the receiver node, feedback indicating decoding was unsuccessful for the two or more of the multiple transport blocks.

In an example aspect of any of the preceding example aspects of the method, the retransmission may include at least one cross-block check block from a first set of cross-block check blocks generated using a first partition of code blocks from each of the two or more of the multiple transport blocks, the retransmission may also include at least one cross-block check block from a second set of cross-block check blocks generated using a second partition of code blocks from each of the two or more of the multiple transport blocks.

In an example aspect of any of the preceding example aspects of the method, after transmitting the retransmission, a respective retransmission count associated with each respective HPN for each of the two or more of the multiple transport blocks may be increased by one.

In another example aspect, the present disclosure describes a method at a receiver node, the method including: transmitting or receiving control information for an initial transmission of multiple transport blocks from a transmitter node, the control information including a respective hybrid automatic repeat request (HARQ) process number (HPN) for each respective one of the multiple transport blocks; receiving, from the transmitter node, the initial transmission of the multiple transport blocks; transmitting or receiving further control information for a retransmission, the further control information including the respective HPN for each of two or more of the multiple transport blocks; and receiving, from the transmitter node, a retransmission of one or more cross-block check blocks generated from code blocks selected from across the two or more of the multiple transport blocks.

In an example aspect of the preceding example aspect of the method, the method may include: transmitting, to the transmitter node, feedback indicating decoding was unsuccessful for the two or more of the multiple transport blocks.

In an example aspect of any of the preceding example aspects of the method, the retransmission may include at least one cross-block check block from a first set of cross-block check blocks generated using a first partition of code blocks from each of the two or more of the multiple transport blocks, the retransmission may also include at least one cross-block check block from a second set of cross-block check blocks generated using a second partition of code blocks from each of the two or more of the multiple transport blocks.

In another example aspect, the present disclosure describes an apparatus including: a processing unit; and a memory including instructions that, when executed by the processing unit, cause the apparatus to perform any preceding examples of the preceding example aspects of the methods.

In another example aspect, the present disclosure describes a non-transitory computer readable medium having machine-executable instructions stored thereon, wherein the instructions, when executed by an apparatus, cause the apparatus to perform any preceding examples of the preceding example aspects of the methods

In another example aspect, the present disclosure describes an apparatus including: a transmitting module configured to carry out the transmitting steps of any preceding examples of the preceding example aspects of the methods; and/or a receiving module configured to carry out the receiving steps of any preceding examples of the preceding example aspects of the methods.

In another example aspect, the present disclosure describes a processing module configured to control an apparatus to cause the apparatus to carry out any preceding examples of the preceding example aspects of the methods.

In another example aspect, the present disclosure describes a system chip including a processing unit configured to execute instructions to cause an apparatus to carry out any preceding examples of the preceding example aspects of the methods.

In another example aspect, the present disclosure describes a computer program characterized in that, when the computer program is run on a computer, the computer is caused to execute any preceding examples of the preceding example aspects of the methods.

### BRIEF DESCRIPTION OF THE DRAWINGS

Reference will now be made, by way of example, to the accompanying drawings which show example embodiments of the present application, and in which:

FIG. 1 illustrates an example wireless communication system, in which examples of the present disclosure may be implemented;

FIG. 2 illustrates an example apparatus that may be used to implement examples of the present disclosure;

FIG. 3 illustrates an example of how cross-block check blocks may be generated from information bits selected across multiple code blocks of one TB, in accordance with examples of the present disclosure;

FIG. 4 illustrates an example of how cross-TB check blocks may be generated from information bits selected from code blocks across multiple TBs, in accordance with examples of the present disclosure;

FIGS. 5A and 5B illustrate examples of how cross-TB check blocks may be generated from information bits selected from a subset (or partition) of code blocks of multiple TBs, in accordance with examples of the present disclosure;

FIGS. 6A-6C illustrate examples of how code block partitioning may be used to generate cross-block check blocks for one or more retransmissions, in accordance with examples of the present disclosure;

FIGS. 6D and 6E are flowcharts illustrating example methods at a transmitter node and at a receiver node, for a retransmission scheme using cross-block check blocks with code block partitioning, in accordance with examples of the present disclosure;

FIGS. 7A and 7B are signaling diagrams illustrating example retransmission schemes, where multiple TBs are indicated by a common HARQ process number, in accordance with examples of the present disclosure;

FIGS. 7C and 7D are flowcharts illustrating example methods at a transmitter node and at a receiver node, using example retransmission schemes where multiple TBs are indicated by a common HARQ process number, in accordance with examples of the present disclosure;

FIG. 8A is a signaling diagram illustrating an example retransmission scheme, where different TBs are indicated by different HARQ process numbers, in accordance with examples of the present disclosure;

FIGS. 8B and 8C are flowcharts illustrating example methods at a transmitter node and at a receiver node, using an example retransmission scheme where different TBs are indicated by different HARQ process numbers, in accordance with examples of the present disclosure; and

FIG. 9 illustrates example state transitions for HARQ process management.

Similar reference numerals may have been used in different figures to denote similar components.

### DETAILED DESCRIPTION

To assist in understanding the present disclosure, an example wireless communication system is first described.

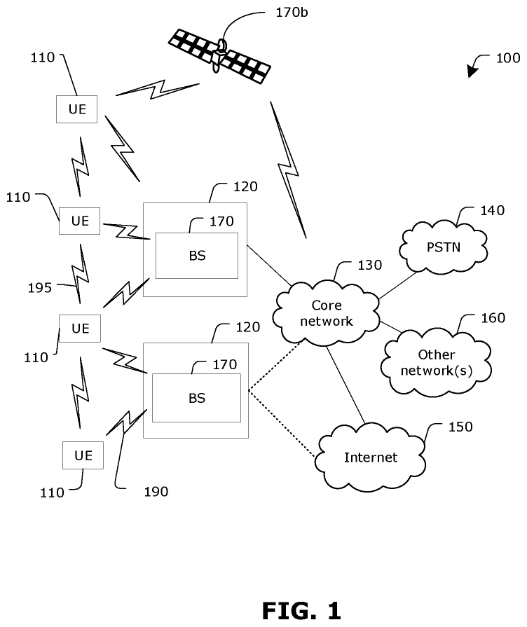

FIG. 1 illustrates an example wireless communication system 100 (also referred to as a wireless system 100) in which embodiments of the present disclosure could be implemented. In general, the wireless system 100 enables multiple wireless or wired elements to communicate data and other content. The wireless system 100 may enable content (e.g., voice, data, video, text, etc.) to be communicated (e.g., via broadcast, groupcast, multicast, narrowcast, device to device, etc.) among entities of the system 100. The wireless system 100 may operate by sharing resources such as bandwidth. The wireless system 100 may be suitable for wireless communications using 5G technology (e.g., 5G New Release (NR) and Long-Term Evolution (LTE) technologies) and/or later generation wireless technology. In some examples, the wireless system 100 may also accommodate some legacy wireless technology (e.g., 3G or 4G wireless technology).

In the example shown, the wireless system 100 includes user equipment (UEs) 110, radio access networks (RANs) 120, a core network 130, a public switched telephone network (PSTN) 140, the internet 150, and other networks 160. In some examples, one or more of the networks may be omitted or replaced by a different type of network. Other networks may be included in the wireless system 100. Although certain numbers of these components or elements are shown in FIG. 1, any reasonable number of these components or elements may be included in the wireless system 100.

The UEs 110 are configured to operate, communicate, or both, in the wireless system 100. For example, the UEs 110 may be configured to transmit, receive, or both via wireless or wired communication channels. The term “UE” may be used to refer to any suitable end user device for wireless operation and may include such devices (or may be referred to) as a wireless transmit/receive unit (WTRU), a mobile station, a mobile relay, a fixed or mobile subscriber unit, a cellular telephone, a station (STA), a machine type communication (MTC) device, a personal digital assistant (PDA), a smartphone, a laptop, a computer, a tablet, a wireless sensor, an internet of things (IoT) device, a network-enabled vehicle, or a consumer electronics device, among other possibilities. In some examples, the term electronic device (ED) may be used instead of UE. In general, it should be understood that the use of the term UE in the present disclosure does not necessarily limit the present disclosure to any specific wireless technology.

In FIG. 1, the RANs 120 include base stations (BSs) 170. Although FIG. 1 shows each RAN 120 including a single respective BS 170, it should be understood that any given RAN 120 may include more than one BS 170, and any given RAN 120 may also include base station controller(s) (BSC), radio network controller(s) (RNC), relay nodes, elements, and/or devices. FIG. 1 also depicts a non-terrestrial BS 170b, which may be part of a non-terrestrial network (not shown). A non-terrestrial BS 170b may also be referred to as a satellite. The non-terrestrial BS 170b may communicate with the core network 130 using satellite transmissions. A non-terrestrial BS 170b may wirelessly communicate with one or more UEs 110, similar to terrestrial BSs 170. Communications between a non-terrestrial BS 170b and a UE 110 (which is typically a terrestrial entity) may be slower compared to communications between a terrestrial BS 170 and a UE 110, due to the longer distance between a non-terrestrial BS 170b and a UE 110. For simplicity, a non-terrestrial BS 170b may be referred to as simply a BS 170, except where explicitly stated.

Each BS 170 is configured to wirelessly interface with one or more of the UEs 110 to enable access to any other BS 170, the core network 130, the PSTN 140, the internet 150, and/or the other networks 160. For example, the BSs 170 may also be referred to as (or include) a base transceiver station (BTS), a radio base station, a Node-B (NodeB), an evolved NodeB (eNodeB or eNB), a Home eNodeB, a gNodeB (gNB) (sometimes called a next-generation Node B), a transmission point (TP), a transmission and reception point (TRP), a site controller, an access point (AP), or a wireless router, among other possibilities. Future generation BSs 170 may be referred to using other terms. In some examples, the term TRP may be used to encompass a BS 170 or any other node that may serve to transmit and receive communications. Thus, although the present disclosure makes references to BSs 170, it should be understood that this is not intended to be limiting. Any UE 110 may be alternatively or additionally configured to interface, access, or communicate with any other BS 170, the internet 150, the core network 130, the PSTN 140, the other networks 160, or any combination of the preceding. In some examples, a BS 170 may access the core network 130 via the internet 150.

The UEs 110 and BSs 170 are examples of communication equipment that can be used to implement some or all of the functionality and/or embodiments described herein. Any BS 170 may be a single element, as shown, or multiple elements, distributed in the corresponding RAN 120, or otherwise. Each BS 170 transmits and/or receives wireless signals within a particular geographic region or area, sometimes referred to as a “cell” or “coverage area”. A cell may be further divided into cell sectors, and a BS 170 may, for example, employ multiple transceivers to provide service to multiple sectors. In some embodiments there may be established pico or femto cells where the radio access technology supports such. A macro cell may encompass one or more smaller cells. The number of networks (including terrestrial networks and non-terrestrial networks) shown is exemplary only. Any number of networks may be contemplated when devising the wireless system 100.

The BSs 170 communicate with one or more of the UEs 110 over one or more uplink (UL)/downlink (DL) wireless interfaces 190 (e.g., via radio frequency (RF), microwave, infrared, etc.). The UL/DL interface 190 may also be referred to as a UL/DL connection, UE-BS link/connection/interface, or UE-network link/connection/interface, for example. The UEs 110 may also communicate directly with one another (i.e., without involving the BS 170) via one or more sidelink (SL) wireless interfaces 195. The SL interface 195 may also be referred to as a SL connection, UE-to-UE link/connection/interface, vehicle-to-vehicle (V2V) link/connection/interface, vehicle-to-everything (V2X) link/connection/interface, vehicle-to-infrastructure (V2I) link/connection/interface, vehicle-to-pedestrian (V2P) link/connection/interface, device-to-device (D2D) link/connection/interface, or simply as SL, for example. The wireless interfaces 190, 195 may utilize any suitable radio access technology. For example, the wireless system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) for wireless communications.

The RANs 120 are in communication with the core network 130 to provide the UEs 110 with various services such as voice, data, and other services. The RANs 120 and/or the core network 130 may be in direct or indirect communication with one or more other RANs (not shown), which may or may not be directly served by core network 130, and may or may not employ the same radio access technology. The core network 130 may also serve as a gateway access between (i) the RANs 120 or UEs 110 or both, and (ii) other networks (such as the PSTN 140, the internet 150, and the other networks 160). In addition, some or all of the UEs 110 may include functionality for communicating with different wireless networks over different wireless links using different wireless technologies and/or protocols. Instead of wireless communication (or in addition thereto), the UEs 110 may communicate via wired communication channels to a service provider or switch (not shown), and to the internet 150. PSTN 140 may include circuit switched telephone networks for providing plain old telephone service (POTS). The internet 150 may include a network of computers and subnets (intranets) or both, and incorporate protocols, such as Internet Protocol (IP), Transmission Control Protocol (TCP), User Datagram Protocol (UDP). The UEs 110 may be multimode devices capable of operation according to multiple radio access technologies, and incorporate multiple transceivers necessary to support such.

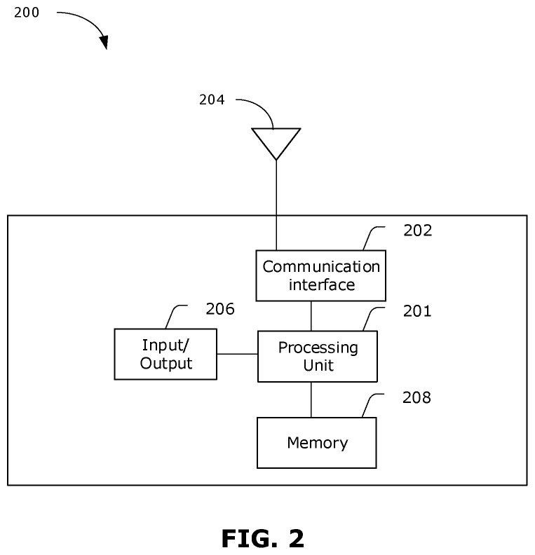

FIG. 2 illustrates an example apparatus 200 that may implement examples disclosed herein. FIG. 2 illustrates a possible embodiment for the UE 110 or the BS 170, for example, and is not intended to be limiting.

As shown in FIG. 2, an example apparatus 200 (e.g., an example embodiment of the UE 110 or BS 170) includes at least one processing unit 201. The processing unit 201 implements various processing operations of the apparatus 200. For example, the processing unit 201 could perform signal coding, data processing, power control, input/output processing, or any other functionality of the apparatus 200. The processing unit 201 may also be configured to implement some or all of the functionality and/or embodiments described in more detail herein. Each processing unit 201 includes any suitable processing or computing device configured to perform one or more operations. Each processing unit 201 could, for example, include a microprocessor, microcontroller, digital signal processor, field programmable gate array, or application specific integrated circuit. Each of the at least one processing unit 201 may include one or more processor cores.

The apparatus 200 includes at least one communication interface 202 for wired and/or wireless communications. One or multiple communication interfaces 202 could be used in the apparatus 200. Each communication interface 202 includes any suitable structure for generating signals for wireless or wired transmission and/or processing signals received wirelessly or by wire. Although shown as a single functional unit, the communication interface 202 could also be implemented using at least one transmitter interface and at least one separate receiver interface. In some examples, one or more transmitters and one or more receivers may be implemented by the communication interface 202.

The apparatus 200 includes one or more antennas 204 for wireless communications. Each antenna 204 includes any suitable structure for transmitting and/or receiving wireless signals. In some examples, the apparatus 200 may include multiple antennas 204 to support multiple-input multiple-output (MIMO) communications. There may be multiple antennas 204 that together form an antenna array, which may be used for beamforming and beam steering operations. In some examples, there may be one or more antennas 204 used for transmitting signals and separate one or more antennas 204 used for receiving signals. Although the communication interface 202 is shown to couple the processing unit 201 to the one or more antennas 204 in FIG. 2, the communication interface 202 may, in other examples, couple the processing unit 201 to other units or modules within the apparatus 200, or to other devices outside the apparatus 200. Accordingly, references herein to receiving or transmitting signals also encompass inputting or outputting signals, respectively.

The apparatus 200 further includes one or more input/output devices 206 or input/output interfaces (such as a wired interface to the internet 150). The input/output device(s) 206 permit interaction with a user or other devices in the wireless system 100. Each input/output device 206 includes any suitable structure for providing information to or receiving information from a user, such as a speaker, microphone, keypad, keyboard, display, or touchscreen, including network interface communications.

In addition, the apparatus 200 includes at least one memory 208. The memory 208 stores instructions and data used, generated, or collected by the apparatus 200. For example, the memory 208 could store software instructions or modules configured to implement some or all of the functionality and/or embodiments described herein and that are executed by the processing unit(s) 201. Each memory 208 includes any suitable volatile and/or non-volatile storage and retrieval device(s). Any suitable type of non-transitory memory may be used, such as random access memory (RAM), read only memory (ROM), hard disk, optical disc, subscriber identity module (SIM) card, memory stick, secure digital (SD) memory card, and the like.

In wireless communication systems, a BS 170 may transmit data (e.g., a transport block (TB)) to one or more UEs 110. A TB can be segmented and encoded (e.g., by forward error correction (FEC) codes) to generate multiple code blocks (CBs) for transmission. Additionally, several CBs in TB can be grouped to form a code block group (CBG). The code used for the encoding may be a systematic code or a non-systematic code. A CB generally includes information bits and check bits. The information bits represent data and the check bits represent redundancy bits that may be used for error correction. It will be appreciated by persons skilled in the art that the present disclosure is not dependent on whether systematic or non-systematic code is used. For simplicity, examples disclosed herein may be in the context of systematic code. It should be understood that this is not intended to be limiting.

Hybrid automatic repeat request (HARQ) is a commonly used retransmission technique. Conventional HARQ retransmission schemes are typically based on whether a TB was successfully decoded by a receiver node. If the receiver node was unsuccessful in decoding even one CB of a TB, then negative feedback is sent back to the transmitter node and the transmitter node performs a retransmission of the entire TB (e.g., a single TB may form a transmission packet) or a predefined group of CBs (referred to as a CB group (CBG)) containing the unsuccessfully decoded CB, even if other CBs of the TB or CBG were successfully decoded by the receiver node. This may be an inefficient use of communication resources. The inefficiency of conventional HARQ retransmission schemes may be exacerbated in broadcast, multicast or groupcast scenarios, in which different receiver nodes may have errors in decoding different CBs. A retransmission of a TB or CBG that contains a CB that was not successfully decoded by one receiver node may be redundant for another receiver node that did successfully decode all the CBs of the TB or CBG.

Retransmission schemes based on the use of cross-block check blocks (also referred to as cross-packet check blocks or vertical check blocks) have been described. For example, techniques for generating cross-block check blocks have been described in U.S. patent application Ser. No. 16/665,121, entitled “SYSTEM AND METHOD FOR HYBRID-ARQ”, filed Oct. 28, 2019, the entirety of which is hereby incorporated by reference. The use of cross-block check blocks in network coding (also referred to as 2D network coding or 2D joint network coding) has been described in U.S. patent application Ser. No. 17/110,226, entitled “METHODS AND SYSTEMS FOR NETWORK CODING USING CROSS-PACKET CHECK BLOCKS”, filed Dec. 2, 2020; and in U.S. patent application Ser. No. 17/368,500, entitled “METHODS AND SYSTEMS FOR BROADCAST MULTICAST OR GROUPCAST TRANSMISSION USING VERTICAL CHECK BLOCKS”, filed Jul. 6, 2021, the entireties of which are hereby incorporated by reference.

In general, a cross-block check block is formed by check bits that are generated from information bits selected from across two or more different CBs. A cross-block check block may be generated by, for example, selecting information bits from across two or more CBs, then encoding (e.g., using a FEC code, such as low-density parity-check (LDPC) code) or otherwise combining (e.g., using XOR, linear combination, etc.) the selected bits to obtain the cross-block check block. In some examples, a cross-block check block may be referred to as a “vertical” check block, to distinguish from a “horizontal” check block such as a conventional cyclic redundancy check (CRC) block that is generated using information bits of a single CB.

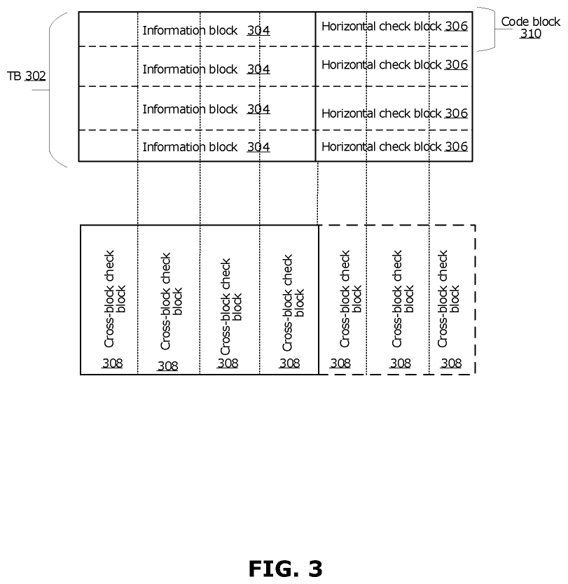

An example of how cross-block check blocks may be generated is now described with reference to FIG. 3.

FIG. 3 illustrates an example code structure for a single TB 302 that is segmented into multiple CBs 310 (in this example, four CBs 310 are shown for simplicity, however this is not intended to be limiting). Each CB 310 includes an information block 304 formed from encoder input bits. The encoder input bits may also be referred to as information bits. Each CB 310 also includes check bits (e.g., cyclic redundancy check (CRC) bits) generated using the bits from the information block 304 of the CB 310. The check bits, which are appended to the information block 304 of the CB 310, may be referred to as a horizontal check block 306. As shown, there may be one horizontal check block 306 in each CB 310. The term “horizontal” refers to how the check bits in the horizontal check block 306 are generated using only the information bits from a single CB 310 (as distinguished from cross-block check blocks, which may be referred to as “vertical” check blocks), and is not intended to imply any physical structure or orientation. A horizontal check block 306 may also be referred to as an intra-block check block or a single-CB check block, among other possibilities.

One or more cross-block check blocks 308 are generated using bits selected from across two or more CBs 310. The cross-block check blocks 308 may include one or more cross-block check blocks 308 generated from bits selected across multiple information blocks 304. Optionally, one or more cross-block check blocks 308 may also be generated using bits selected from across multiple horizontal check blocks 306. Cross-block check blocks 308 generated from bits selected from horizontal check blocks may be referred to as “check on check” blocks.

In some examples, cross-block check blocks 308 may be referred to as vertical check blocks (to distinguish from the horizontal check blocks 306), however the term “vertical” is not intended to imply any physical structure or orientation. Further, it should be understood that the terms “parity block” or “redundancy block” may also be used instead of “check block”. In FIG. 3, each cross-block check block 308 is generated using bits selected from across two or more CBs 310 of the information blocks 304.

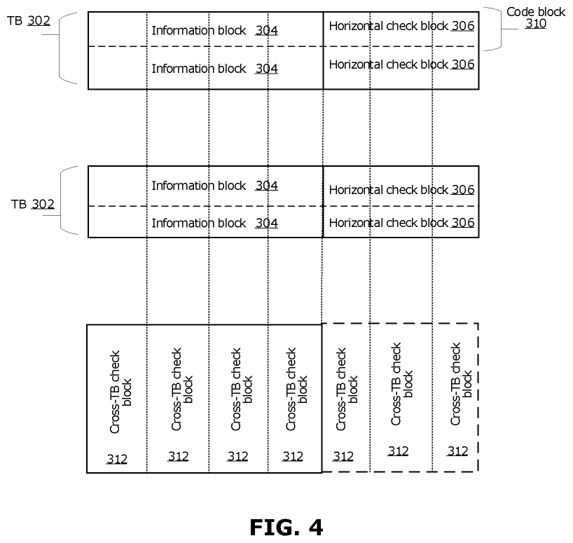

FIG. 4 illustrates an example in which cross-block check blocks are generated using bits selected from across two different TBs 302. In the present disclosure, the term “cross-TB check block” may be used to specifically refer to a check block generated using bits selected from across two (or more) different TBs 302, to distinguish from a check block generated using bits selected from across CBs of a single TB 302 (i.e., the cross-TB check blocks 312 shown in FIG. 4 may be distinguishable from the cross-block check blocks 308 shown in FIG. 3).

Although two TBs 302 are shown, it should be understood that there may be more than two TBs 302. As well, the number of CBs 310 in each TB 302 may or may not be equal. FIG. 4 illustrates an example in which each cross-TB check block 312 is generated using bits selected from across the CBs 310 of two or more TBs 302. As will be discussed further below, in some examples cross-TB check blocks 312 may be generated using bits selected from a subset of CBs 310 of the two or more TBs 302, rather than from all CBs 310 as shown in FIG. 4.

In general, each cross-TB check block 312 is generated from bits selected from at least one CB 310 of each of two or more TBs 302. The selected bits may be referred to as cross-TB bits (because the bits are selected from across multiple TBs 302), and the group of selected bits may be referred to as the cross-TB information block. The cross-TB information block is then encoded (e.g., using a FEC code, such as LDPC code) or otherwise combined (e.g., using XOR, linear combination, etc.) to obtain the cross-TB check block 312. In general, the term check block should be understood to encompass various techniques that may be used to combine bits selected from across different TBs 302, including using XOR or using a linear combination of bits as well as encoding techniques such as encoding the selected bits using a channel code (among other possibilities).

In some examples, an interleaver may be used to select the cross-TB bits. Examples of how an interleaver may be used in a cross-block check block retransmission scheme are described in PCT application no. PCT/CN2021/121483, “METHODS AND APPARATUSES FOR WIRELESS COMMUNICATION RETRANSMISSION USING CHECK BLOCKS GENERATED ACCORDING TO SUBBLOCK INTERLEAVERS”, filed Sep. 28, 2021, the entirety of which is hereby incorporated by reference. Discussions of an interleaver in the context of a single-TB based retransmission scheme may be similarly applicable to multiple-TB based retransmissions schemes as disclosed herein.

The manner in which cross-TB bits are selected (e.g., which interleaver to use, which CBs 310 from which TB 302 are selected, how many bits to select from the selected CBs 310, etc.) and the manner in which the cross-TB check blocks 312 are generated (e.g., what combination or encoding technique to use, how many cross-TB check blocks 312 to generate, whether check-on-check blocks are generated, etc.) may be configured by the transmitter node and/or by a network controller, and/or may be defined by a standard.

The check bits contained in the horizontal check blocks 306 and cross-TB check blocks 312 are useful to assist decoding at a receiver node. For example, after each decoding operation (also referred to as a decoding attempt) at a decoder, error checking can be performed using check bits to determine if the information bits of the TB 302 have been successfully decoded. Each cross-TB check block 312 contains check bits generated from across multiple TBs 302, and thus provides information useful for decoding multiple TBs 302. The decoder may use the check bits of the cross-TB check block 312 to assist in decoding of a TB 302.

In examples where systematic code is used (such as LDPC code or Turbo code), an iterative decoding process may be used at the decoder at the receiver node to decode the received TB 302. The decoder calculates log-likelihood ratios (LLRs) of bit values during decoding, which may be considered a “soft” output of the decoder. In the present disclosure, soft output may refer to decoder output that is not yet finalized (e.g., bit value not yet definitively determined to be 1 or 0 value) but may provide information that can still be useful (e.g., in a subsequent decoding iteration). Such soft output may be probabilistic in nature (e.g., LLR). A TB 302 that is not correctly decoded (e.g., at least one CB 310 of the TB 302 fails a check using the corresponding horizontal check blocks 306) may benefit from information encoded in the cross-TB check blocks 312. Because each of the cross-TB check blocks 312 is generated from information bits selected from two or more different TBs 302, soft output from decoding operations to decode a cross-TB check block 312 may help to improve decoding of multiple TBs 302. In at least this way, cross-TB check blocks 312 help to improve decoding.

In the present disclosure, a HARQ retransmission scheme that makes use of cross-TB check blocks may be referred to as cross-TB HARQ.

NR wireless communication supports asynchronous retransmission (e.g., UL retransmission as well as DL retransmission). Asynchronous retransmission means that retransmission of a TB is not timing based. Thus, in asynchronous retransmission, a receiver node requires the TB being retransmitted to be indicated in a control signal. An example of a conventional HARQ retransmission scheme is now described. Conventionally, each TB is identified by a HARQ process number (HPN). The retransmission of a given TB and feedback related to the given TB are associated with the HPN of the given TB. When a transmission is scheduled, whether the transmission is an initial transmission or a retransmission is indicated by a new data indicator (NDI) in a control signal. Generally, the NDI is a binary indicator which is either toggled or not toggled; determination of whether a transmission of a TB is an initial transmission or a retransmission may be based on whether the NDI is toggled on/off compared to the NDI associated with a previous transmission of the same TB (as indicated by having the same HPN).

A drawback of the conventional HARQ retransmission scheme is that each retransmission is based on a single TB. If there are multiple TBs requiring retransmission, each TB must be retransmitted separately. This is the case even if each TB only has one CB that was not decoded successfully at the receiver. The result is that significant communication resources may be wasted to transmit information that was already successfully decoded at the receiver.

Examples of the present disclosure describe methods and systems that may help to improve efficiency of retransmission in unicast, groupcast, multicast and/or broadcast wireless communications. The present disclosure describes the use of cross-TB check blocks in a retransmission, which enables information to assist in decoding multiple TBs to be provided in one retransmission. Examples of the present disclosure describe how a set of cross-TB check blocks may be generated using a subset of CBs from different TBs. Examples of the present disclosure also describe signaling that may be used to indicate to a receiver node which TBs were used to generate the cross-TB check blocks in a retransmission. It should be understood that examples disclosed herein may be implemented independently of each other, as well as in combination.

Reference is again made to FIG. 4. In the example shown, each cross-TB check block 312 is generated by selecting information bits from each CB 310 of each TB 302, across multiple TBs 302. Each cross-TB check block 312 thus provides information that can be used by a receiver node to help decoding of any of the CBs 310 in any of the TBs 302. However, because each cross-TB check block 312 contains information from all CBs 310, decoding of the cross-TB check block 312 at the receiver node may be more complex.

An example technique for generating cross-TB check blocks 312 from a subset of CBs 310 across multiple TBs 302 is now described, which may help to reduce the decoding complexity of the cross-TB check blocks 312.

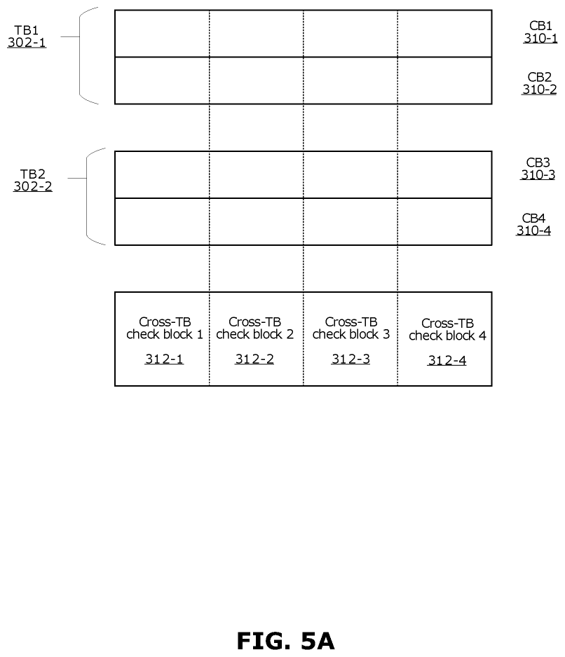

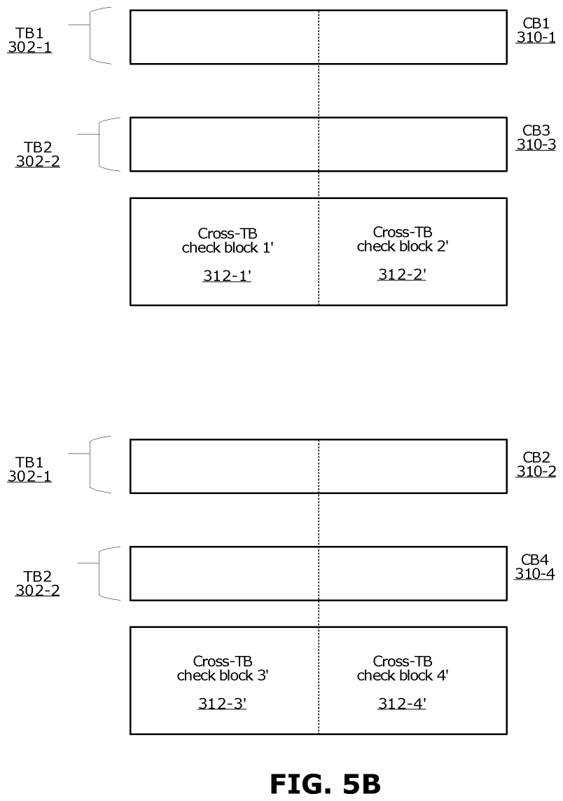

To assist in understanding, FIG. 5A is first described, which is similar to the example shown in FIG. 4, with additional annotation. For simplicity, the horizontal check blocks have been omitted; however, it should be understood that there may be a horizontal check block for each CB 310.

FIG. 5A illustrates two TBs, specifically TB1 302-1 and TB2 302-2 (generally referred to as TB 302), each having two CBs (generally referred to as CB 310), specifically CB1 310-1 and CB2 310-2 belong to TB1 302-1, and CB3 310-3 and CB4 310-4 belong to TB2 302-2. It should be understood that the number of TBs 302 and number of CBs 310 illustrated are only for simplicity; in general, there may be two or more TBs 302, and each TB 302 may have two or more CBs 310. Additionally, the number of CBs 310 in each TB 302 may or may not be equal.

In the example of FIG. 5A, each cross-TB check block (generally referred to as cross-TB check block 312) is generated using bits selected from each CB 310 of each TB 302. For example, cross-TB check block 1 312-1 is generated by combining (e.g., encoding, linear combination, XOR, etc.) bits selected from each of CB1 310-1, CB2 310-2, CB3 310-3 and CB4 310-4. Similarly, cross-TB check block 2 312-2, cross-TB check block 3 312-3 and cross-TB check block 4 312-4 are also each generated by combining different bits selected from each of CB1 310-1, CB2 310-2, CB3 310-3 and CB4 310-4.

The CBs 310 from different TBs 302 may have the same size (i.e., same number of information bits for each CB 310), in which case the number of bits selected from each CB 310 to generate a cross-TB check block 312 may be equal (or almost equal). In other examples, the number of information bits in the CBs 310 of different TBs 302 may be different, in which case the number of bits selected from each CB 310 to generate a cross-TB check block 312 may be different. For example, the number of bits selected from each CB 310 to generate a cross-TB check block 312 may be proportional to the size of each CB 310. This may be done by dividing the information bits of each CB 310 into the same number of subblocks (where the subblocks within a CB 310 have equal or approximately equal number of bits) and then selecting the bits from one subblock of each CB 310 to generate one cross-TB check block 312. This approach may be applicable to all the examples involving cross-TB check block generation described herein.

The use of subblock interleavers for generating the cross-TB check blocks 312 need not be discussed in detail here. However, it should be understood that various methods for selecting the bits for generating each cross-TB check block 312 and various methods for combining the selected bits, as discussed in the references previously incorporated by reference, may be used. In particular, a particular subblock interleaver that is used to generate a particular set of cross-TB check blocks 312 may be associated to a particular redundancy version (RV). Thus, the cross-TB check blocks 312 generated for a particular RV may provide different information from another set of cross-TB check blocks 312 generated for a different RV.

The four cross-TB check blocks 312 generated in the example of FIG. 5A are generated using a particular subblock interleaver for a particular RV. If only one retransmission is scheduled for the two TBs 302, the transmitter node may transmit all four cross-TB check blocks 312 in one retransmission (or may transmit at least one of the four cross-TB check blocks 312 in one retransmission). If two retransmissions are scheduled for the two TBs 302, the transmitter node may transmit two cross-TB check blocks 312 (e.g., cross-TB check blocks 1 and 2 312-1, 312-2) in one retransmission and the remaining two cross-TB check blocks 312 (e.g., cross-TB check blocks 3 and 4 312-3, 312-4) in a second retransmission, both retransmissions having the same RV. Alternatively, if two retransmissions are scheduled, the transmitter node may transmit all four cross-TB check blocks 312 in the first retransmission using one RV, then generate another set of four cross-TB check blocks 312 using a different RV for the second retransmission.

However, as described above, decoding of the cross-TB check blocks 312 at the receiver node may be complex, because each cross-TB check block 312 contains information from a large number of CBs 310.

FIG. 5B illustrates an example of how cross-TB check blocks 312 may be generated from bits selected from fewer than all CBs 310 across multiple TBs 302. This technique for generating cross-TB check blocks 312 may be referred to as a CB partitioning technique, and may help to reduce complexity.

CB partitioning refers to a technique of dividing the CBs 310 of two or more different TBs 302 into different subsets (or partitions), such that each TB 302 is partitioned into two or more partitions, each partition including at least one CB 310 but fewer than all CBs 310 of a given TB 302. Then a set of cross-TB check blocks 312 is generated by selecting bits from one partition of each TB 302. In this way, a set of cross-TB check blocks 312 is generated using bits selected from at least one CB 310 of each TB 302, but fewer than all CBs 310 across all TBs 302.

FIG. 5B shows TB1 302-1, which has CB1 310-1 and CB2 310-2, and TB2 302-2, which has CB3 310-3 and CB4 310-4, similar to the example of FIG. 5A. However, each TB 302 is partitioned into two partitions, where each partition contains one CB 310. Then each cross-TB check block is generated by selecting one partition from each TB 302. In this example, the first partition of TB1 302-1 consists of CB1 310-1 and the second partition of TB1 302-1 consists of CB2 310-2; and the first partition of TB2 302-2 consists of CB3 310-3 and the second partition of TB2 302-2 consists of CB4 310-4. Then cross-TB check block 1′ 312-1′ is generated from bits selected from only the first partition of each TB 302 (i.e., CB1 310-1 (first partition of TB1 302-1) and CB3 310-3 (first partition of TB2 302-2)); cross-TB check block 2′ 312-2′ is generated from different bits selected from the first partition of each TB 302; cross-TB check block 3′ 312-3′ is generated from bits selected from only the second partition of each TB 302 (i.e., CB2 310-2 (second partition of TB1 302-1) and CB4 310-4 (second partition of TB2 302-2)); and cross-TB check block 4′ 312-4′ is generated from different bits selected from the second partition of each TB 302.

Notably, each cross-TB check block 312 is still generated using bits selected from multiple TBs 302, though not necessarily all CBs 310 of each TB 302. Thus, retransmission using cross-TB check block 312 still provides information to assist in decoding of multiple TBs 302. Further, by selecting appropriate cross-TB check blocks 312 to send together in a retransmission, it may be possible for one retransmission to provide information to assist in decoding of all CBs 310 across the multiple TBs 302, even if one cross-TB check block 312 does not provide sufficient information to assist in decoding of all CBs 310. That is, it is possible to select cross-TB check blocks 312 generated using different partitions of CBs 310 such that the different partitions together cover all CBs 310.

For example, if cross-TB check block 1′ 312-1′ (generated from the respective first partition of each TB 302) and cross-TB check block 3′ 312-3′ (generated from the respective second partition of each TB 302) are sent together in one retransmission, then the retransmission will include check blocks generated from bits selected from across all four CBs 310. If a second retransmission is performed, then cross-TB check block 2′ 312-2′ and cross-TB check block 4′ 312-4′ may be similarly sent together in the second retransmission.

The result of CB partitioning is that a set of cross-TB check blocks 312 is generated from a subset of CBs 310, which includes at least one CB 310 from each of two or more TBs 302. In this way, decoding complexity may be reduced. In the example of FIG. 5B, the CBs 310 of each TB 302 may be partitioned into two approximately equal partitions, such that two sets of cross-TB check blocks 312 are generated from the two respective partitions of each TB 302. The CBs 310 of a given TB 302 may be partitioned such that each partition contains approximately the same number of CBs 310. Thus, if the number of CBs 310 in TB1 302-1 is at a given proportion to the number of CBs 310 in TB2 302-2 (e.g., TB1 302-1 has double the number of CBs 310 as TB2 302-2), then the number of CBs 310 in each partition of TB1 302-1 may be at the same or similar proportion to the number of CBs 310 in each partition of TB2 302-2 (e.g., the number of CBs 310 in the first partition of TB1 302-1 is double the number of CBs 310 in the first partition of TB2 302-2).

It should be noted that the CBs 310 may be partitioned into more than two partitions. For example, if there are two TBs 302 each with four CBs 310, each TB 302 may be partitioned into two partitions where each partition contains two CBs 310, or each TB 302 may be partitioned into four partitions where each partition contains one CB 310. The selection of how CBs 310 may be partitioned may be based on how much complexity is desired and/or other potential performance criteria. The CBs 310 selected for a given partition may be based on, for example, different time-frequency resources, different spatial resources, order of CBs 310, etc. The CB partitioning (e.g., number of CBs 310 in each partition, or number of partitions) may be determined by the transmitter node (e.g., at the time of transmission), may be preconfigured or defined by a standard, for example.

If there are multiple retransmissions, diversity gain may be increased by selecting cross-TB check blocks 312 generated from different partitions to send in each retransmission. In the example of FIG. 5B, consider the scenario where TB1 302-1 and TB2 302-2 are sent in initial transmissions, cross-TB check block 1′ 312-1′ and cross-TB check block 3′ 312-3′ are sent in a first retransmission, and cross-TB check block 2′ 312-2′ and cross-TB check block 4′ 312-4′ are sent in a second retransmission. If the initial transmissions and both retransmissions experience independent fading, a maximum diversity order of four can be obtained even if each cross-TB check block 312 is generated from only two CBs 310, while at the same time decoding complexity is reduced. It may be assumed that the initial transmission of TB1 302-1, initial transmission of TB2 302-2, first retransmission and second retransmission each experiences independent channel conditions (e.g., independent fading). Then, because joint decoding is used, with cross-TB check blocks 312 assisting in decoding of CBs 310, the maximum diversity gain of all four transmissions can be achieved. For example, if CB1 310-1 (included in TB1 302-1) is sent in the first initial transmission, CB3 310-3 (included in TB2 302-2) is sent in the second initial transmission, cross-TB check block 1′ 312-1′ (generated from CB1 310-1 and CB3 310-3) is sent in the first retransmission, and cross-TB check block 2′ 312-2′ (generated from CB1 310-1 and CB3 310-3) is sent in the second retransmission, then joint decoding of CB1 310-1 and CB3 310-3 will be assisted by information from all four transmissions, thus having diversity gain of all four transmissions.

Although the CB partitioning technique has been described in the context of cross-TB check blocks 312, it should be understood that a similar CB partitioning technique may be used for generation of cross-block check blocks generated from one TB 302. For example, decoding complexity may be reduced by generating a set of cross-block check blocks from fewer than all CBs of one TB 302. If CBs 310 are grouped into CB groups (CBGs) in one TB 302, CB partitioning may be performed to partition the CBs 310 of each CBG.

In general, the generation of cross-TB check blocks or cross-block check blocks using the disclosed CB partitioning technique may be applicable to generation of cross-TB check blocks across multiple TBs, generation of cross-block check blocks across multiple CBGs (which may belong to the same TB or different TBs), or in general across multiple data blocks.

It may be noted that, in the example where CB partitioning is used for generation of cross-block check blocks across multiple CBGs, the CBs that belong to the same CBG may be predefined in advance (e.g., based on a standard, or preconfigured) or may be determined by the transmitter node based on various factors. For example, it may be useful to group CBs into CBGs in such a way that different CBGs are likely to experience independent channel variations or decoding errors (e.g., different partitions may be in different frequency band, different time slots, different MIMO layers, different beams, etc.). Similarly, different data blocks may be assigned to different transmissions, in different frequency band, different time slots, different MIMO layers, different beams etc. In this way, diversity gain may be maximized, and the performance of joint decoding may be improved.

In general, the CB partitioning technique disclosed herein may be applicable to partitioning of CBs belonging to a TB, CBs belonging to a CBG or more generally CBs belonging to data blocks.

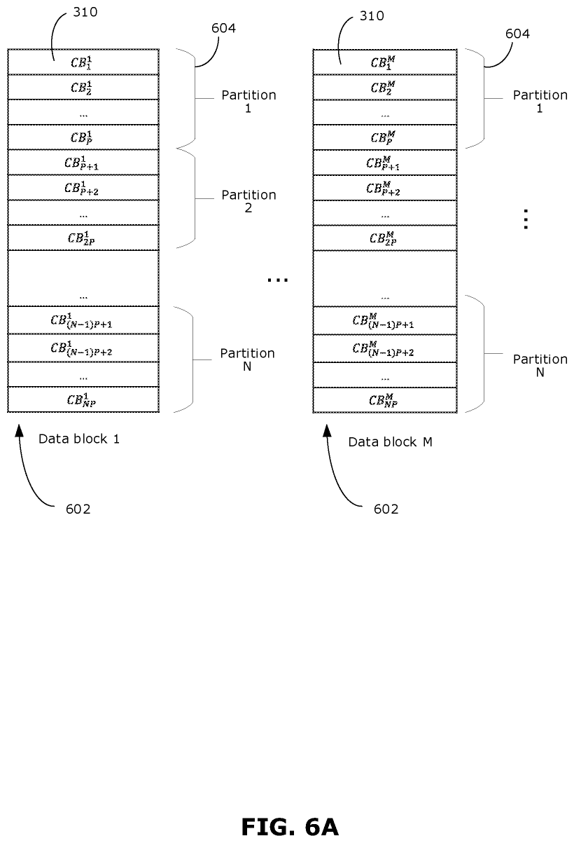

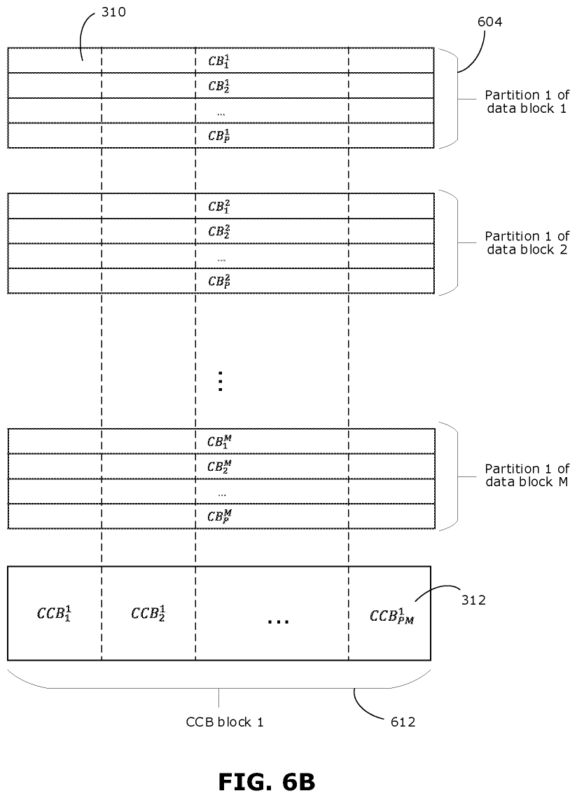

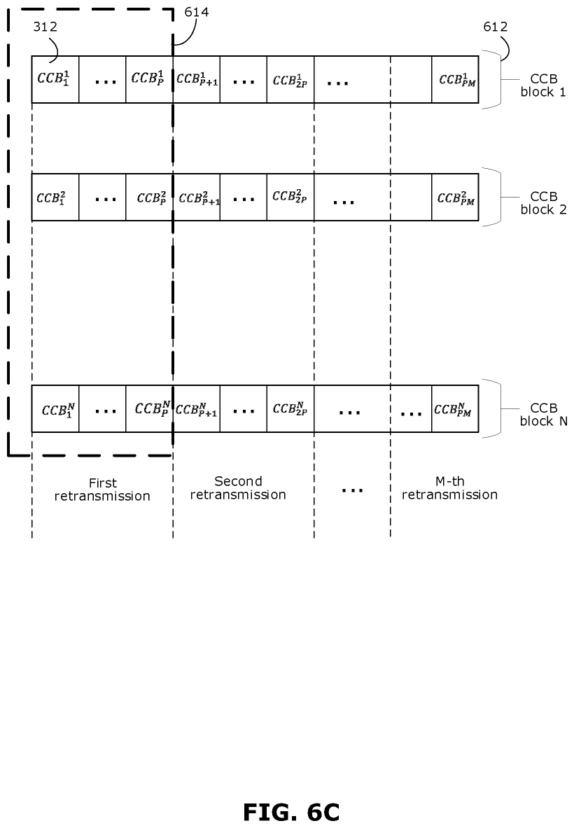

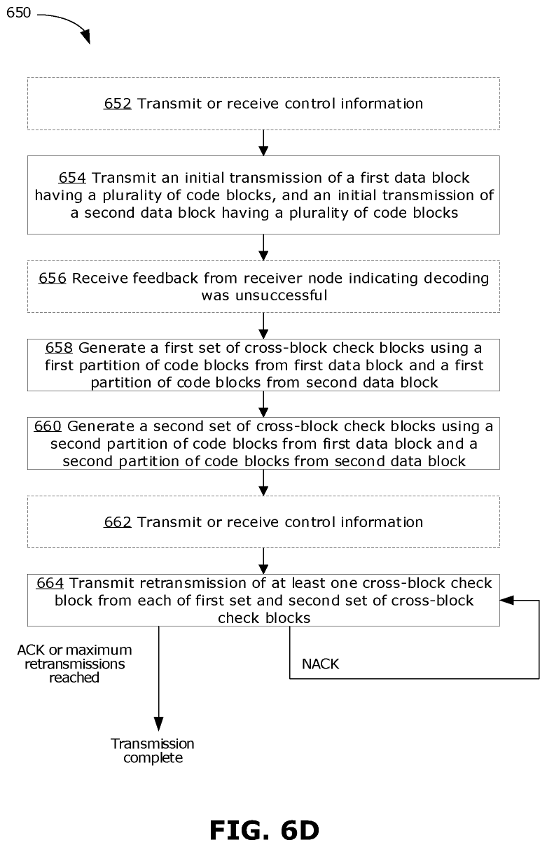

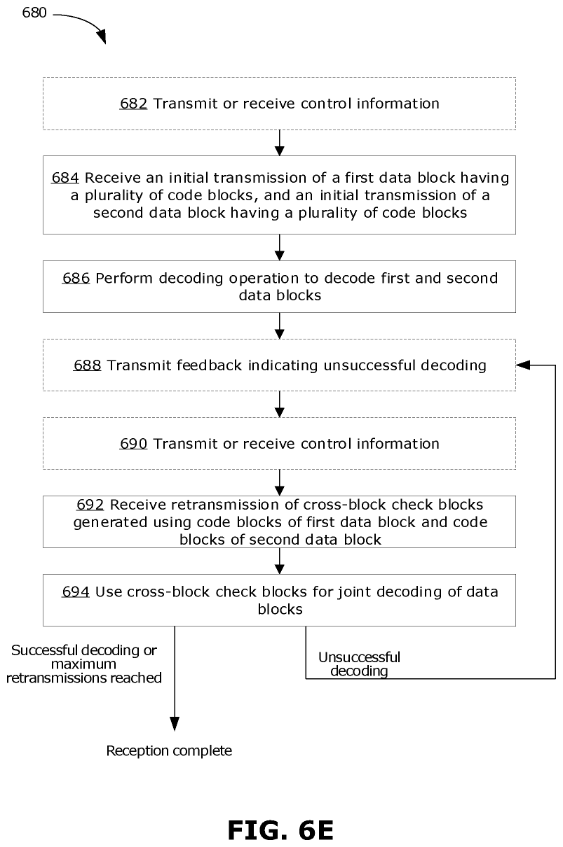

FIGS. 6A-6C illustrate an example where there are M data blocks 602 (e.g., M TBs or M CBGs), and each data block 602 is divided into N partitions 604, each partition containing an equal number of P CBs 310, where P is an integer and P>=1, such that each data block 602 contains P×N CBs 310. In FIGS. 6A-6C, the notation CBⁱⱼ is used to denote the j-th CB belonging to the i-th data block. It should be noted that in some examples, the total number of CBs 310 in each data block 602 may not be divisible by N, thus each partition 604 may contain an approximately equal (rather than strictly equal) number of CBs 310.

Then cross-block check blocks 312 (which may encompass cross-TB check blocks) may be generated by selecting (e.g., in accordance with an interleaver) one partition 604 from each of the M data block 602s, such that M partitions 604 are selected. Then the information bits of the selected partitions 604 are combined (e.g., using any suitable coding scheme) to produce a set of cross-block check blocks 312. Since there are M selected partitions 604 and P CBs 310 per partition 604, the cross-block check blocks 312 are generated from information bits selected from P×M CBs 310. It may be assumed that the number of cross-block check blocks 312 generated in this way is equal to the number of CBs 310 in the selected partitions 604, thus there may be P×M cross-block check blocks 312 generated.

In the example illustrated by FIG. 6B, partition 1 of each data block 602 is selected for generating a first set of cross-block check blocks 312, which may be grouped together as a first cross-block check block block 612 (CCB block 612). In FIG. 6B, the notation CCBⁱⱼ is used to denote the j-th cross-block check block generated for the i-th CCB block 612. As shown in this example,

$$C C {B}_{1}^{1}$$

to

$$C C {B}_{P M}^{1}$$

may be grouped together as CCB block 1. In a similar manner, partition 2 of each data block 602 may be used to generate a second set of cross-block check blocks 312, which may be grouped together as CCB block 2. By repeating this procedure for all N partitions, there may be a total of N CCB blocks 612 generated.

Reference is now made to FIG. 6C. In this example, P CCBs 312 from each of the N CCB blocks 612 are selected as a CCB group 614 with P×N CCBs to be transmitted together in one retransmission. For example, the CCBs 312 that form the CCB group 614 used to perform the first retransmission are

$$C C {B}_{1}^{1}$$

to

$$C C {B}_{P}^{1}$$

selected from CCB block 1;

$$CC {B}_{1}^{2}$$

to

$$C C {B}_{P}^{2}$$

selected from CCB block 2; and so forth until

$$C C {B}_{1}^{N}$$

to

$$C C {B}_{P}^{N}$$

of CCB block N. Thus, the first retransmission contains a CCB group 614 with P×N cross-block check blocks 312. It should be appreciated that because the first retransmission contains cross-block check blocks 312 selected from each of the N CCB blocks 612, the cross-block check blocks 312 transmitted in the first retransmissions provides information that may assist in decoding the CBs 310 in all N partitions 604 of all M data blocks 602.

If a second retransmission is required, the second retransmission may be performed using another CCB group 614 formed by selecting the next P cross-block check blocks 312 from each of the N CCB blocks 612 (e.g.,

$$C C {B}_{P + 1}^{1}$$

to

$$C C {B}_{2 P}^{1}$$

are selected from CCB block 1, and so forth as shown in FIG. 6C). In this way, M retransmissions may be performed with the generated cross-block check blocks 312, with each retransmission containing P×N cross-block check blocks 312.

In the above example, if the M data blocks 602 each experience an independent channel, and each retransmission among the M retransmission of cross-block check blocks 312 also experience an independent channel, then joint decoding may still obtain a diversity order of 2×M. Since the example CB partitioning technique described above reduces the number of CBs 310 selected for generation of each set of cross-block check blocks 312 from M×P×N to P×N, the decoding complexity may be significantly reduced. At the same time, the diversity gain may be sufficient to maintain good performance.

In the example CB partitioning technique disclosed herein, the partitioning of CBs and grouping of cross-block check blocks into CCB blocks may be based on grouping together data blocks and cross-block check blocks that are more likely to experience similar channel conditions. This may be done such that different partitions of CBs and different CCB groups are more likely to experience independent channel conditions, to help increase the diversity gain. For example, different data blocks may be allocated in different bands, different time slots, different MIMO layers, different beams, etc. Similarly, different CCB groups may have different frequency bands, different time slots, different MIMO layers, different beams, etc.

Thus, the present disclosure describes an example for performing retransmissions using cross-TB check blocks, in which CB partitioning may be used to help decrease the decoding complexity while also helping to maintain the diversity gain. The disclosed CB partitioning technique may be more generally extended to cross-block check blocks (e.g., where cross-block check blocks are generated across multiple CBGs or across multiple packets).

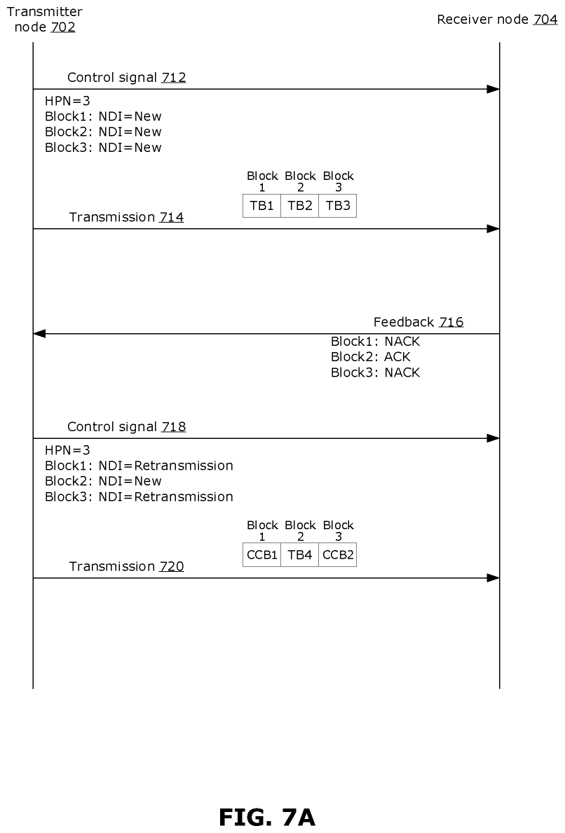

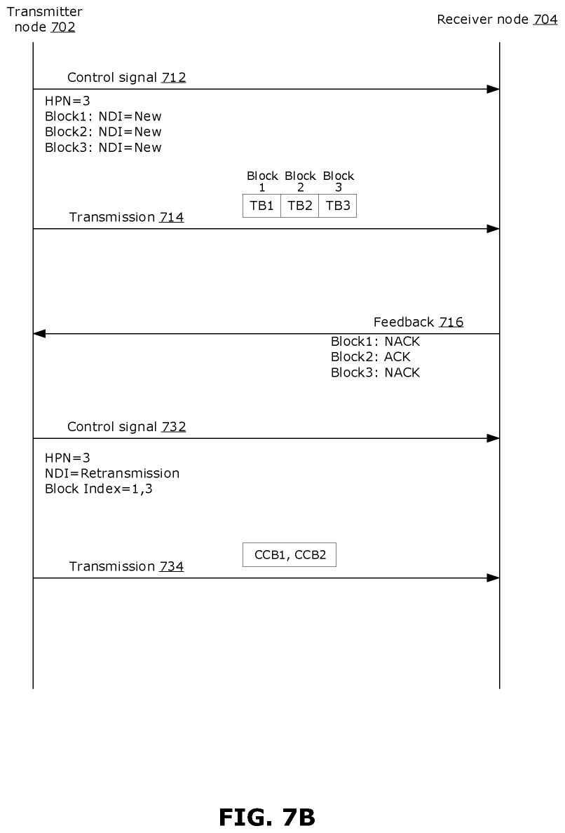

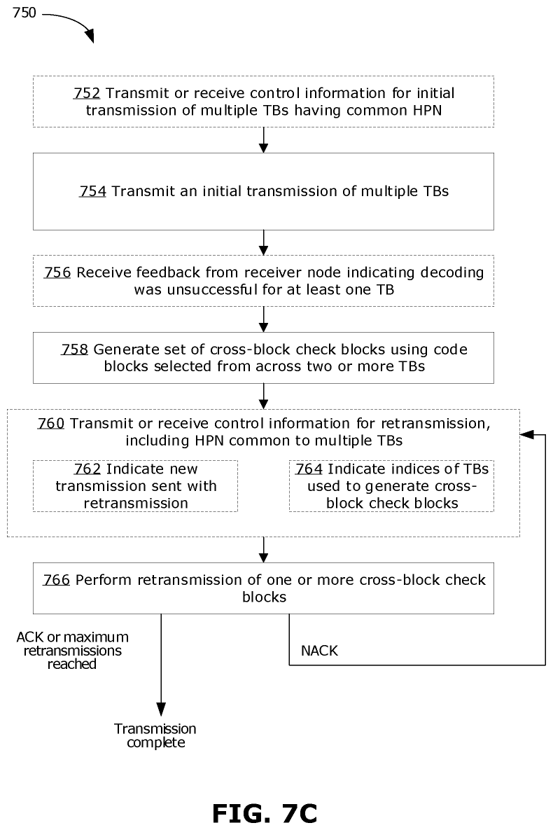

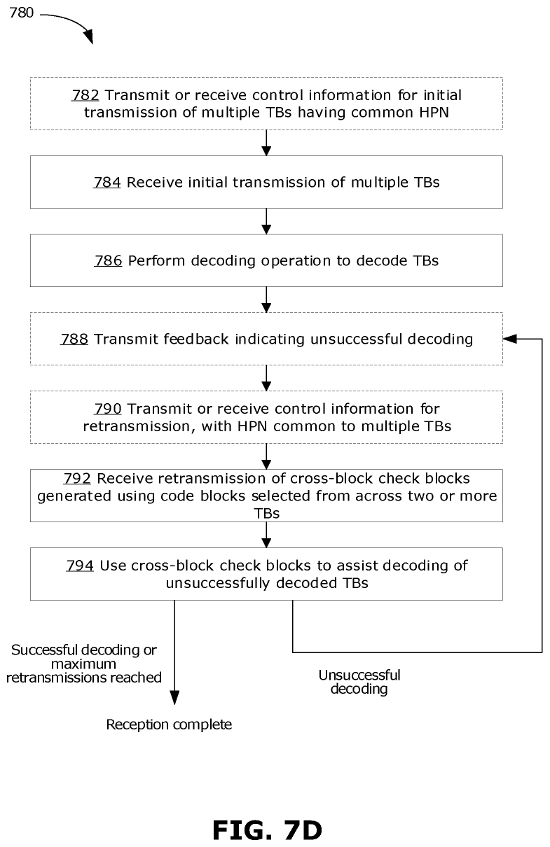

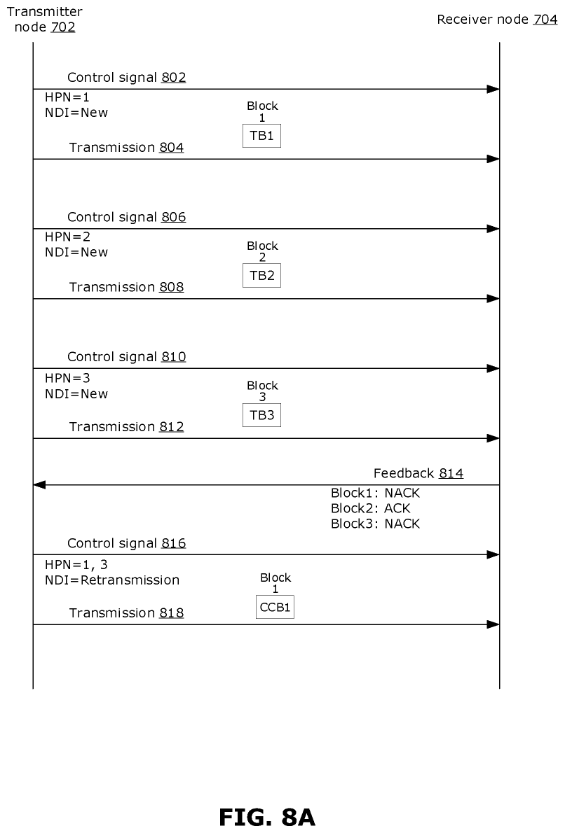

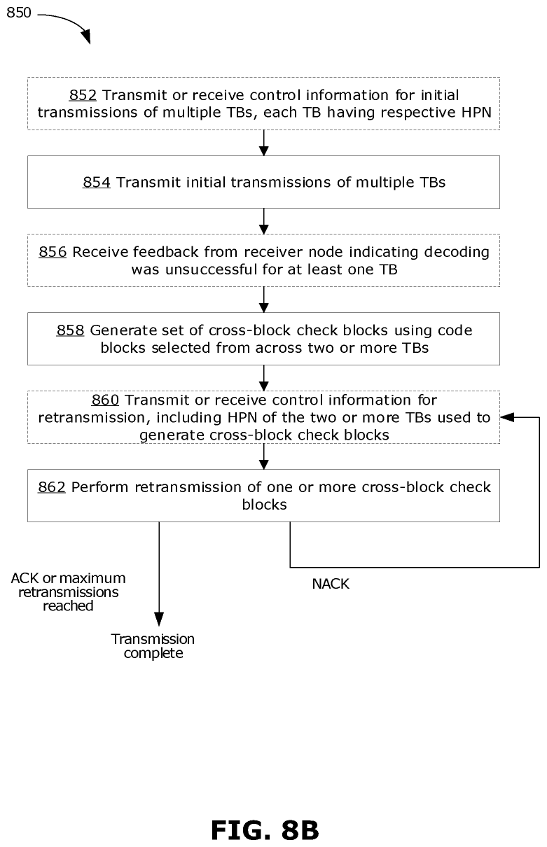

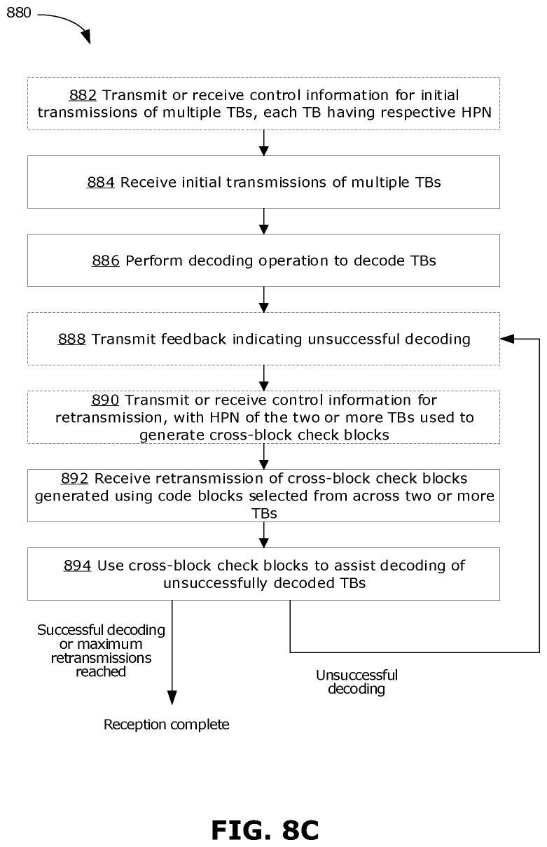

FIG. 6D is a flowchart illustrating an example method 650, which may be performed by an apparatus (e.g., the apparatus 200 of FIG. 2) that is a transmitter node. For example, the method 650 may be performed by a BS 170 for DL transmissions, or may be performed by a UE 110 for UL or SL transmissions. The method 650 may be performed for unicast, multicast, groupcast or broadcast transmissions. The method 650 may be used to perform retransmissions using cross-block check blocks (where cross-block check block are generated across multiple CBGs, across multiple packets, or across multiple TBs). The method 650 may be used to perform retransmission using cross-block check blocks generated using bits selected from across multiple TBs, in which case the cross-block check blocks may be more specifically referred to as cross-TB check blocks. The method 650 may be performed by the transmitter node in any of the examples described herein, including the examples illustrated by FIGS. 7A, 7B and 8A further below.

Optionally, at 652, the transmitter node may transmit or receive control information (e.g., depending on DL, UL or SL transmission). For example, in DL transmission, if the transmitter node is the network entity responsible for scheduling transmissions (e.g., a BS), then the transmitter node may transmit the control information in a DCI to the receiver node (e.g., a UE). In another example, in UL transmission, the transmitter node may be the UE, and the transmitter node may receive control information in a DCI from a network entity (e.g., BS that is the receiver node) instead. In another example, in SL transmission, the transmitter node may be a first UE and the receiver node may be a second UE. For SL transmission, the transmitter node may optionally send control information in a SCI to the receiver node to indicate the transmission resources. If the transmission resources for the SL transmission is scheduled by a network entity (e.g., BS), optionally and additionally, the transmitter node (first UE) may in addition receive a control channel from the network entity in DCI before transmitting the control information.

The control information may include, for example, information about the resource block on which the receiver node may receive data as well as information (e.g., MCS, RV, etc.) to enable the receiver node to decode the received data.

At 654, the transmitter node transmits an initial transmission of a first data block (e.g., first TB, first CBG, first packet, etc.) having a plurality of CBs, and an initial transmission of a second data block (e.g., second TB, second CBG, second packet, etc.) having a plurality of CBs. As shown in the example of FIG. 6A, the CBs in each of the first and second data blocks may be partitioned, such that each data block is formed of two or more partitions each having equal or approximately equal number of CBs. The number of partitions in each data block may be equal. Although two data blocks are described, it should be understood that this may be generalized to initial transmissions of two or more data blocks.

Optionally, if the transmitter node receives feedback (e.g., ACK) indicating decoding was successful for both initial transmissions, the transmission for the current data is complete and the method 650 may end.

Optionally, at 656, the transmitter node may receive feedback from the receiver node indicating that decoding was unsuccessful. The feedback may, for example, be a NACK for each of the data blocks, a NACK for all data blocks, or a NACK indicating decoding is unsuccessful for at least one of the data blocks. In some examples, absence of feedback from the receiver node (e.g., absence of ACK) may be interpreted by the transmitter node as indicating that decoding was unsuccessful. In other examples, the transmitter node may be configured to perform a predefined number of retransmissions in the absence of feedback from the receiver node.

In some examples, the transmitter node may not receive any feedback from the receiver node. For example, there may not be any feedback sent by the receiver node in UL communications; instead, the receiver node (e.g., the BS in UL communications) may itself schedule a retransmission if decoding was unsuccessful. In another example, an “ACKless” (ACK-less) or “NACKless” (NACK-less) feedback scheme may be used, in which case retransmissions may be performed until a predefined maximum number of retransmissions has been reached.

At 658, the transmitter node generates a first set of cross-block check blocks using a first partition of CBs from the first data block and a first partition of CBs from the second data block. The first set of cross-block check blocks is generated by selecting the first partition from each of the first and second data blocks, then combining (e.g., using XOR or encoding) the information bits of the CBs in the selected partitions to generate the first set of cross-block check blocks (e.g., as shown in the example of FIG. 6B).

At 660, the transmitter node generates a second set cross-block check blocks using a second partition of CBs from the first data block and a second partition of CBs from the second data block. Step 660 may be similar to step 658, with the difference being the selection of different partitions.

Although the generation of two sets of cross-block check blocks are described, it should be understood that this may be generalized to generate two or more sets of cross-block check blocks. Each i-th set of cross-block check blocks may be generated by selecting a corresponding i-th partition across the two (or more) data blocks. This may be repeated until all partitions have been used for generation of cross-block check blocks.

Optionally, at 662, the transmitter node may transmit or receive control information. Similar to step 652 described previously, the transmitter node may transmit control information or may receive control information, depending on the DL, UL or SL scenario.

The control information may include information to enable the receiver node to decode the retransmission (e.g., MCS, etc.). The control information may include, for example, indication of the first and second data blocks, the time frequency and other resources used for retransmission, information about any partitioning of the CBs (e.g., indication of how many partitions or how many CBs in each partition), any interleaver (e.g., the subblock interleaver) or other information indicating how bits were selected to generate each cross-block check block, and/or information about the encoding used to generate the cross-block check blocks (e.g., code rate, redundancy version, etc.).

At 664, the transmitter node transmits a retransmission of at least one cross-block check block from each set of cross-block check blocks that were generated. For example, the retransmission may include a subset of cross-block check block(s) from the first set of cross-block check blocks (generated at step 658) as well as a subset of cross-block check block(s) from the second set of cross-block check blocks (generated at 660). An example is illustrated in FIG. 6C.

If, following the retransmission at step 664, the transmitter node receives feedback indicating unsuccessful decoding at the receiver node (e.g., receives NACK) or in the absence of feedback indicating successful decoding (e.g., in the absence of ACK), the method 650 returns to step 664 to transmit another retransmission. Another retransmission may be performed by selecting a different subset of cross-block check block(s) from each generated set of cross-block check blocks. If, following the retransmission at step 664, the transmitter node receives feedback indicating successful decoding (e.g., receives ACK) or the maximum number of retransmission has been reached, the transmission for the current data is complete and the method 650 may end. In some examples, the transmitter node may not receive any feedback from the receiver node (such as in UL communications, or in ACKless or NACKless feedback schemes), as previously described.

FIG. 6E is a flowchart illustrating an example method 680, which may be performed by an apparatus (e.g., the apparatus 200 of FIG. 2) that is a receiver node. For example, the method 680 may be performed by a UE 110 receiving DL transmissions or SL transmissions, or may be performed by a BS 170 receiving UL transmissions. The method 680 may be performed in unicast, multicast, groupcast or broadcast scenarios. The method 680 may be used to receive retransmissions of cross-block check blocks (where cross-block check block are generated across multiple CBGs, across multiple packets, or across multiple TBs). The method 680 may be used to receive retransmission using cross-block check blocks generated using bits selected from across multiple TBs, in which case the cross-block check blocks may be more specifically referred to as cross-TB check blocks. The method 680 may be performed by the receiver node in any of the examples described herein, including the examples illustrated by FIGS. 7A, 7B and 8A further below.

Optionally, at 682, the receiver node may transmit or receive control information (e.g., depending on DL, UL or SL transmission). For example, in DL transmission, the receiver node may be a UE and the transmitter node may be a BS, in which case the receiver node may receive the control information in a DCI from the transmitter node. In another example, in UL transmission, the receiver node may be a BS and the transmitter node may be a UE, in which case the receiver node may transmit control information to the transmitter node in a DCI. In another example, in SL transmission, the transmitter node may be a first UE and the receiver node may be a second UE, in which case the receiver node may receive the control information in a SCI from the transmitter node.

The control information may include, for example, information about the resource block on which the receiver node may receive data as well as information (e.g., MCS, RV, etc.) to enable the receiver node to decode the received data. If the receiver node is responsible for scheduling transmissions (e.g., if the receiver node is the BS), step 682 may be omitted and the receiver node may instead transmit control information.

At 684, the receiver node receives an initial transmission of a first data block (e.g., first TB, first CBG, first packet, etc.) having a plurality of CBs, and an initial transmission of a second data block (e.g., second TB, second CBG, second packet, etc.) having a plurality of CBs.

At 686, the receiver node performs a decoding operation (also referred to as a decoding attempt) to decode the data blocks.

If decoding of all the data blocks is successful, the receiver node may send feedback (e.g., ACK) to the transmitter node to indicate successful decoding. In some examples, the receiver node may not send feedback when decoding is successful and the absence of feedback may indicate successful decoding. In some examples, if the receiver node is responsible for scheduling transmissions (e.g., if the receiver node is the BS), no feedback may be required. If decoding is successful, reception of the current data is complete and the method 680 may end.

Optionally, if decoding is unsuccessful, at 688, the receiver node may transmit feedback (e.g., NACK) indicating unsuccessful decoding. In some examples, absence of feedback from the receiver node may indicate unsuccessful decoding and step 688 may be omitted. In some examples, the receiver node may be configured to not send any feedback regardless of whether decoding was successful or not. In some examples, such as examples where the receiver node is responsible for scheduling transmissions (e.g., the receiver node is the BS), the receiver node may not need to send any feedback.

Optionally, at 690, the receiver node may transmit or receive control information. Similar to step 682 described previously, the receiver node may transmit control information or may receive control information, depending on the DL, UL or SL scenario.

The control information may include information to enable the receiver node to decode the retransmission (e.g., MCS, etc.) and to use the retransmission to assist in decoding the data blocks.

At 692, the receiver node receives a retransmission of cross-block check blocks that were generated using CBs of the first data block and CBs of the second data block. As previously described, the cross-block check blocks sent in the retransmission may be a subset of different sets of cross-block check blocks, where each set of cross-block check blocks was generated using selected partitions across the data blocks.

At 694, the receiver node uses the received cross-block check blocks for joint decoding of the data blocks. If decoding is still unsuccessful, this may be indicated in feedback (e.g., NACK) to the transmitter node at optional step 688 or absence of feedback may indicate unsuccessful decoding. If all data blocks are successfully decoded, the receiver node may transmit feedback (e.g., ACK) to the transmitter node or absence of feedback may indicate successful decoding. In some examples, such as in UL communications, no feedback may be required. If decoding is successful or the maximum number of retransmissions has been reached, reception of the current data is complete and the method 680 may end.

The present disclosure also describes example techniques for adapting the use of HPN for cross-TB check blocks. As previously discussed, in conventional retransmission schemes that perform retransmissions of TBs (rather than cross-TB check blocks), the retransmission of each TB is identified based on the HPN indicated in the control signal. However, when a retransmission uses cross-TB check blocks, as disclosed herein, a different signaling scheme is required in order to identify the TBs used to generate the cross-TB check blocks in a retransmission.

The present disclosure describes a signaling scheme in which a single HPN may be used to identify multiple TBs used for generating a set of cross-TB check blocks. A single HPN, which identifies multiple TBs, may be indicated in a control signal to schedule the initial transmission of the multiple TBs. Then a retransmission using cross-TB check blocks generated from the multiple TBs may be indicated using the same HPN. Using a single HPN to indicate multiple TBs may be relatively simple to implement, with little impact on existing control signaling. The present disclosure also describes another signaling scheme in which each TB is identified by a respective HPN. Then a retransmission using cross-TB check blocks generated from multiple TBs may be indicated using the multiple HPNs corresponding to the multiple TBs. Using multiple HPNs to indicate multiple TBs covered by a retransmission may provide more flexibility because the TBs to be combined for a retransmission does not need to be predefined. Further details of these example signaling schemes are provided below.

Although the examples discussed below refer to the downlink transmission of TBs, it should be understood that the signaling scheme disclosed herein may be adapted for transmission of data blocks in general (e.g., packets or any uplink or downlink data transmissions).

FIG. 7A is a signaling diagram illustrating an example of the present disclosure in which a single HPN is used to indicate multiple TBs in a transmission. In this example, a single transmitter node 702 transmits data to a single receiver node 704. In examples of DL transmission, the transmitter node 702 may be a BS 170 and the receiver node 704 may be a UE 110. In examples of UL or SL transmission, the transmitter node 702 may be a UE 110 and the receiver node 704 may be a BS 170 or another UE 110. For simplicity, the signaling is illustrated for DL transmissions. However, it should be understood that UL, SL or DL transmissions are all possible as discussed below.

The transmitter node 702 sends control information in a control signal 712 to the receiver node 704. The control information may be sent as a DCI signal or a SCI signal, for example. The control information may provide information about the time-frequency resource block on which a following data transmission is to be received, the modulation and coding scheme used, and other information that may be used by the receiver node 704 to decode the data. As previously mentioned, FIG. 7A illustrates a DL scenario, and the transmitter node 702 may be a BS that transmits a DCI signal. In a UL scenario, where the transmitter node 702 is a UE and the receiver node 704 is a BS, the control information may instead be sent by the receiver node 704 to the transmitter node 702. In yet other scenarios, the control information may be sent by another network entity that is not the transmitter node 702 or the receiver node 704.

Regardless of which network entity sends the control information, the control information may provide information about the time frequency resource allocated to each data block in a following data transmission. For example, each data block may have different time frequency resource allocations and may also possibly have different space domain allocations (e.g., different MIMO layers, different antenna port, different beams, different TRPs etc.). In some example, different data blocks may share some common resource allocation parameters, for example different data blocks may have the same frequency allocation (thus only need to signal the frequency allocation for one of the data blocks), and in time domain the different data blocks may share the allocation of the same symbols but on different slots (thus only the slot number for each data block need to be signaled) and other time frequency resource allocation may be common. In another example, such as in MIMO, multiple data blocks may be allocated on different MIMO layers, but may share the same time frequency resources, thus the time frequency resources for all data blocks may only need to be signaled once. For simplicity, the example of FIG. 7A does not show the allocation of time frequency resources in the control signal 712.

In this example, all data blocks (denoted as Block1, Block2, Block3) share the same HPN (HPN=3 as shown in FIG. 7A), but each data block may have its own NDI (as well as other information such as MCS and RV). For example, the control information in the control signal 712 may include control information that is common to all data blocks scheduled by the control signal 712, such as: a common HPN that is common to all data blocks, a total number of data blocks scheduled, a common frequency resource allocation, a common time resource allocation (e.g., which symbols in a slot are used). Additionally, the control information may include control information that is specific to each data block, such as: data block index for each data block, an NDI for each data block (in the control signal 712, the NDI indicates a new transmission for each data block), the MCS for each data block, the RV for each data block, and the slot location for each data block.

Generally, NDI is a field in the control information to indicate whether a scheduled data transmission is a new transmission or retransmission. NDI usually only contains one bit, which can be represented by either 0 or 1. One method to indicate whether data is new transmission or retransmission is to compare the NDI in the scheduled transmission with the NDI of the previous scheduled transmission with the same HPN, if the NDI is toggled (i.e., changed from 0 to 1 or from 1 to 0), then a new transmission is indicated; on the contrary, if the NDI is not toggled (i.e., not changed), then a retransmission is indicated. In other examples, the value of the NDI may indicate a new transmission or retransmission (e.g. NDI=0 indicates a new transmission and NDI=1 indicates a retransmission). For simplicity, the present disclosure will describe the NDI as indicating a new transmission (“New”) or a retransmission (“Retransmission”) without limiting the mechanism used (whether toggling or not).

In the example shown in FIG. 7A, the transmitter node 702 sends a control signal 712 with control information scheduling the initial transmission (indicated by NDI=New) of three data blocks (denoted Block1, Block2, Block3). In this example, each data block is a TB, however this is not intended to be limiting. The control signal 712 uses a single HPN (HPN=3) that is common to all scheduled data blocks.

Following the control signal 712, the transmitter node sends a transmission 714 of the data blocks, in this example TB1, TB2 and TB3 corresponding to Block1, Block2 and Block3 respectively. The receiver node 704 receives the transmission 714 and performs a decoding attempt. In this example, the receiver node 704 successfully decodes TB2 but is unsuccessful in decoding TB1 and TB3. In this example, the receiver node 704 sends feedback 716 (which may be NACK for Block1 and Block 3, and ACK for Block2) for each data block. The feedback 716 may be multiplexed such that the feedback for all data blocks is sent in one feedback 716. In other examples, the receiver node 704 may not send feedback (e.g., in the UL scenario, the receiver node 704 may be a BS and feedback may not be required).

The transmitter node 702 receives the feedback 716 and determines that a retransmission is required. Because TB2 in Block2 was successfully decoded, only TB1 and TB3 in Block1 and Block3, respectively, are used to generate cross-TB check blocks (e.g., denoted CCB1 and CCB2). In this example, the transmitter node 702 sends another control signal 718 to schedule the next transmission. As previously noted, in some examples (e.g., UL transmissions) the control information may be sent by the receiver node 704 to the transmitter node 702; in yet other examples the control information may be sent by another network entity. The same HPN (HPN=3) is used to indicate that the next transmission is related to the previously sent data blocks having HPN=3, with NDI set to indicate a retransmission for Block1 and Block3. Because retransmission is not required for Block2 (since TB2 was successfully decoded), new data can be sent in Block2 and the NDI is set to indicate a new transmission for Block2. As such, it is possible to send a new data transmission together with a retransmission, which may be more efficient. The sending of new data on Block2 is optional. In some examples, the transmitter node 702 may not transmit any data in Block2 at all (e.g., Block2 can simply be empty or not scheduled). In the following transmission 720, the transmitter node 702 sends the cross-TB check blocks in Block1 and Block3, while Block2 contains new data (e.g., TB4).

The receiver node 704 uses the cross-TB check blocks in Block1 and Block3 to assist in decoding TB1 and TB3. The receiver node 704 also performs a decoding attempt for TB4. The receiver node 704 may send further feedback (not shown) to indicate successful or unsuccessful decoding.

It should be appreciated that transmitting a new data block together with retransmission of other data blocks and/or using the same HPN to indicate multiple data blocks may be applicable to retransmissions performed without cross-block check blocks. For example, in an alternative scenario, the retransmission may be a retransmission of TB1 and TB3 (instead of CCB1 and CCB2, respectively).

FIG. 7B is a signaling diagram illustrating another example of the present disclosure in which a single HPN is used to indicate multiple TBs in a transmission. The example of FIG. 7B shares similarities to the example of FIG. 7A in the first control signal 712, initial transmission 714 and feedback 716. For simplicity, the signaling is illustrated for DL transmissions. However, it should be understood that UL, SL or DL transmissions are all possible as discussed below.

Compared to the example of FIG. 7A, in the example of FIG. 7B there is no new data transmitted together with a retransmission. Following the feedback 716, the transmitter node 702 generates a set of cross-TB check blocks (denoted CCB1 to CCB3) from TB1 and TB3. Since no new data is transmitted with the retransmission, the transmitter node 702 sends a control signal 732 with control information only for the retransmission. As previously mentioned, FIG. 7B illustrates a DL scenario, and the transmitter node 702 may be a BS. In a UL scenario, where the transmitter node 702 is a UE and the receiver node 704 is a BS, the control information may instead be sent by the receiver node 704 to the transmitter node 702. In yet other scenarios, the control information may be sent by another network entity that is not the transmitter node 702 or the receiver node 704.

In this example, the control information includes the HPN (HPN=3) that is shared by the previously transmitted data blocks. Rather than indicating the NDI for each data block, the control information has a single NDI indicating that the next transmission is a retransmission. The control information also includes a block index indicating the indices of the data blocks used to generate the cross-TB check blocks for the following retransmission (in this example, indices 1, 3). The transmitter node 702 the sends a transmission 734 that contains only the retransmission using cross-TB check blocks, without any new data being transmitted in Block2. In this example, the cross-TB check blocks may be transmitted in a single block (as shown in FIG. 7B). Alternatively, transmitter node 702 may send the cross-TB check blocks generated from TB1 and TB3 in two blocks (e.g., if two cross-TB check blocks are generated). Other examples may be possible.

In some examples, the transmitter node 702 may generate cross-TB check blocks using information bits selected from all TBs of a previous transmission, regardless of whether each TB was successfully decoded or not (e.g., regardless of whether ACK or NACK was received for each TB). For example, the transmitter node 702 may generate cross-TB check blocks using information bits selected from all TBs of a previous transmission when decoding is unsuccessful for any TB of a previous initial transmission. In another example, the transmitter node 702 may generate cross-TB check blocks using information bits selected from all TBs of a previous transmission in the absence of any feedback from the receiver node 704. In such examples, the control information for the retransmission may include the HPN that is common to the TBs of the initial transmission and include the NDI to indicate a retransmission, but the control information may not need to include the indices corresponding to the TBs used to generate the cross-TB check blocks.

Examples in which the cross-TB check blocks are generated from all TBs of a previous initial transmission may be suitable in scenarios where the receiver node 704 is not configured to provide feedback or only provides feedback that is not specific to any data block (e.g., a general ACK to indicate all data blocks were successfully decoded, or NACK to indicate at least one data block was not successfully decoded). This may help to simplify the feedback and/or help to reduce feedback overhead.

In general, using all TBs of a previous initial transmission to generate the cross-TB check blocks may be the default case when no indices are included in the control information scheduling a retransmission. In such examples, in addition to the common HPN shared by all data blocks of an initial transmission, RV and NDI may also be common to all data blocks of the initial transmission. However, each data block may still have its own scheduled time frequency resource.

Thus, FIGS. 7A and 7B illustrate examples in which a common HPN is used to indicate multiple data blocks in a transmission as well as subsequent retransmissions.

FIG. 7C is a flowchart illustrating an example method 750, which may be performed by an apparatus (e.g., the apparatus 200 of FIG. 2) that is a transmitter node. For example, the method 750 may be performed by a BS 170 for DL transmissions, or may be performed by a UE 110 for UL or SL transmissions. The method 750 may be performed for unicast, multicast, groupcast or broadcast transmissions. The method 750 may be used to perform retransmissions using cross-block check blocks (which may be referred to as cross-TB check blocks when the cross-block check blocks are generated using bits selected from across multiple TBs), where a common HPN is shared by multiple TBs. The method 750 may be performed by the transmitter node in the examples illustrated by FIGS. 7A and 7B, for example.

Optionally, at 752, the transmitter node may transmit or receive control information (e.g., depending on DL, UL or SL transmission). For example, in DL transmission, if the transmitter node is the network entity responsible for scheduling transmissions (e.g., a BS), then the transmitter node may transmit the control information in a DCI to the receiver node (e.g., a UE). In another example, in UL transmission, the transmitter node may be the UE, and the transmitter node may receive control information in a DCI from a network entity (e.g., BS that is the receiver node) instead. In another example, in SL transmission, the transmitter node may be a first UE and the receiver node may be a second UE. For SL transmission, the transmitter node may optionally send control information in a SCI to the receiver node to indicate the transmission resources. If the transmission resources for the SL transmission is scheduled by a network entity (e.g., BS), optionally and additionally, the transmitter node (first UE) may in addition receive a control channel from the network entity in DCI before transmitting the control information.

The control information may include, for example, information about the resource block on which the receiver node may receive data as well as information (e.g., MCS, RV, etc.) to enable the receiver node to decode the received data. In particular, the control information for scheduling the initial transmission of multiple TBs includes a common HPN that is shared by the multiple TBs. Additionally, the control information may include an indicator (e.g., NDI) for each TB to indicate that each TB is a new transmission.

At 754, the transmitter node transmits an initial transmission of the multiple TBs.

If the transmitter node receives feedback (e.g., ACK) indicating decoding was successful for all of the transmitted TBs, the transmission for the current data is complete and the method 750 may end.

Optionally, at 756, the transmitter node may receive feedback from the receiver node indicating that decoding was unsuccessful for at least one of the multiple TBs. The feedback may, for example, be a NACK for each of the TBs that was unsuccessful decoded, a NACK for all TBs, or a NACK indicating decoding is unsuccessful for at least one of the TBs. In some examples, absence of feedback from the receiver node (e.g., absence of ACK) may be interpreted by the transmitter node as indicating that decoding was unsuccessful. In other examples, the transmitter node may be configured to perform a predefined number of retransmissions in the absence of feedback from the receiver node.

In some examples, the transmitter node may not receive any feedback from the receiver node. For example, there may not be any feedback sent by the receiver node in UL communications; instead, the receiver node (e.g., the BS) may itself schedule a retransmission if decoding was unsuccessful. In another example, an ACKless or NACKless feedback scheme may be used, in which case retransmissions may be performed until a predefined maximum number of retransmissions has been reached.

At 758, the transmitter node generates a set of cross-block check blocks using CBs selected from across two or more of the multiple TBs. For example, if the feedback indicated that decoding was unsuccessful for two or more of the TBs, the set of cross-block check blocks may be generated using CBs selected from across those two or more unsuccessfully decoded TBs. In another example, the set of cross-block check blocks may be generated using CBs selected from across all of the multiple TBs that were sent in the initial transmission (e.g., if the feedback did not specify which TB was unsuccessfully decoded, or if the transmitter node is configured to generate cross-block check blocks across all TBs). The set of cross-block check blocks is generated combining (e.g., using XOR or encoding) the information bits of the selected CBs to generate the set of cross-block check blocks. In some examples, CB partitioning, as described above, may be used to generate the set of cross-block check blocks.

Optionally, at 760, the transmitter node may transmit or receive control information. Similar to step 752 described previously, the transmitter node may transmit control information or may receive control information, depending on the DL, UL or SL scenario.

The control information includes information to enable the receiver node to decode the retransmission (e.g., MCS, etc.). The control information may include, for example, the time frequency and other resources used for retransmission, the information to identify any partitioning of the CBs (e.g., how many partitions or how many CBs in each partition), any interleaver (e.g., the subblock interleaver) or other information indicating how bits were selected to generate each cross-block check block, and/or information about the encoding used to generate the cross-block check blocks (e.g., code rate, redundancy version, etc.). In particular, the control information for scheduling the retransmission uses the common HPN that is shared by the multiple TBs, to indicate that the retransmission is for the multiple TBs that were previously transmitted using the same common HPN.

Optionally, at 762, the control information may indicate that a new transmission is to be sent with the retransmission. For example, as in the example shown in FIG. 7A, the control information may include an indicator (e.g., NDI) indicating whether each data block contains a retransmission or a new transmission.

Optionally, at 764, the control information may indicate the indices of the TBs used to generate the set of cross-block check blocks. For example, as in the example shown in FIG. 7B, the control information may include an indicator (e.g., NDI) that indicates a retransmission, and also include an indicator of the indices of the TBs used to generate the set of cross-block check blocks.

In some examples, the transmitter node may be configured to generate cross-block check blocks by selecting CBs across all TBs that were transmitted in the initial transmission. In such examples, it may not be necessary for the control information to indicate the indices of the TBs used to generate the set of cross-block check blocks, and a new transmission may not be sent with the retransmission.

At 766, the transmitter node transmits a retransmission of one or more cross-block check blocks from the set of cross-block check blocks that was generated from CBs selected from across two or more of the TBs having the common HPN. The cross-block check block(s) may be used by the receiver node to assist in decoding of the TBs.

If, following the retransmission at step 766, the transmitter node receives feedback indicating unsuccessful decoding at the receiver node (e.g., receives NACK) or in the absence of feedback indicating successful decoding (e.g., in the absence of ACK), the method 750 may return to step 760 to transmit control information for another retransmission (or may return to step 758 to generate another set of cross-block check blocks). If, following the retransmission at step 766, the transmitter node receives feedback indicating successful decoding (e.g., receives ACK) or the maximum number of retransmission has been reached, the transmission for the current data is complete and the method 750 may end. In some examples, the transmitter node may not receive any feedback from the receiver node (such as in UL communications, or in ACKless or NACKless feedback schemes), as previously described.

FIG. 7D is a flowchart illustrating an example method 780, which may be performed by an apparatus (e.g., the apparatus 200 of FIG. 2) that is a receiver node. For example, the method 780 may be performed by a UE 110 receiving DL transmissions or SL transmissions, or may be performed by a BS 170 receiving UL transmissions. The method 780 may be performed in unicast, multicast, groupcast or broadcast scenarios. The method 780 may be used to receive retransmissions using cross-block check blocks (which may be referred to as cross-TB check blocks when the cross-block check blocks are generated using bits selected from across multiple TBs), where a common HPN is shared by multiple TBs. The method 780 may be performed by the receiver node in the examples illustrated by FIGS. 7A and 7B, for example.

Optionally, at 782, the receiver node may transmit or receive control information (e.g., depending on DL, UL or SL transmission). For example, in DL transmission, the receiver node may be a UE and the transmitter node may be a BS, in which case the receiver node may receive the control information in a DCI from the transmitter node. In another example, in UL transmission, the receiver node may be a BS and the transmitter node may be a UE, in which case the receiver node may transmit control information to the transmitter node in a DCI. In another example, in SL transmission, the transmitter node may be a first UE and the receiver node may be a second UE, in which case the receiver node may receive the control information in a SCI from the transmitter node.

The control information may include, for example, information about the resource block on which the receiver node may receive data as well as information (e.g., MCS, RV, etc.) to enable the receiver node to decode the received data. In particular, the control information for scheduling the initial transmission of multiple TBs includes a common HPN that is shared by the multiple TBs. Additionally, the control information may include an indicator (e.g., NDI) for each TB to indicate that each TB is a new transmission.

At 784, the receiver node receives an initial transmission of multiple TBs.

At 786, the receiver node performs a decoding operation (also referred to as a decoding attempt) to decode the TBs.

If decoding of all the TBs is successful, the receiver node may send feedback (e.g., ACK) to the transmitter node to indicate successful decoding. In some examples, the receiver node may not send feedback when decoding is successful and the absence of feedback may indicate successful decoding. In some examples, if the receiver node is responsible for scheduling transmissions (e.g., if the receiver node is the BS), no feedback may be required. If decoding is successful, reception of the current data is complete and the method 780 may end.

Optionally, if decoding of at least one TB is unsuccessful, at 788, the receiver node may transmit feedback (e.g., NACK) indicating unsuccessful decoding. The feedback may be specific to each TB, for example to indicate which of the initially transmitted multiple TBs was successfully decoded and which were unsuccessfully decoded. In other examples, the feedback may be non-specific, for example a NACK may indicate unsuccessful decoding of at least one TB of the multiple TBs, without indicating which TB was unsuccessfully decoded. In some examples, absence of feedback from the receiver node may indicate unsuccessful decoding and step 788 may be omitted. In some examples, the receiver node may be configured to not send any feedback regardless of whether decoding was successful or not. In some examples, such as examples where the receiver node is responsible for scheduling transmissions (e.g., the receiver node is the BS), the receiver node may not need to send any feedback.

Optionally, at 790, the receiver node may transmit or receive control information. Similar to step 782 described previously, the receiver node may transmit control information or may receive control information, depending on the DL, UL or SL scenario.

The control information may include information to enable the receiver node to decode the retransmission (e.g., MCS, etc.) and to use the retransmission to assist in decoding the TBs. In particular, the control information for scheduling the retransmission uses the common HPN that is shared by the multiple TBs, to indicate that the retransmission is for the multiple TBs that were previously transmitted using the same common HPN.

The control information may indicate whether each data block contains a retransmission or a new transmission, for example using a separate NDI for each data block (e.g., as shown in FIG. 7A). The control information may indicate the indices of the TBs used to generate the set of cross-block check blocks (e.g., as shown in FIG. 7B).

At 792, the receiver node receives a retransmission of cross-block check blocks that were generated using CBs selected from across two or more of the multiple TBs of the initial transmission.

At 794, the receiver node uses the received cross-block check blocks to assist in decoding of the unsuccessfully decoded TBs. If decoding is still unsuccessful, this may be indicated in feedback (e.g., NACK) to the transmitter node at optional step 788 or absence of feedback may indicate unsuccessful decoding. If all data blocks are successfully decoded, the receiver node may transmit feedback (e.g., ACK) to the transmitter node or absence of feedback may indicate successful decoding. In some examples, such as in UL communications, no feedback may be required. If decoding is successful or the maximum number of retransmissions has been reached, reception of the current data is complete and the method 780 may end.

It should be understood that these examples may be applicable to scenarios where different TBs (or more generally data blocks) are mapped to different layers of a MIMO transmission. For example multiple TBs mapped to multiple MIMO layers (e.g., based on some layer mapping operation) may share a common HPN, with each TB having its own index, MCS, NDI, RV, etc.

FIG. 8A is a signaling diagram illustrating an example of the present disclosure in which multiple HPNs are used to indicate multiple TBs in a transmission. Similar to the examples of FIGS. 7A and 7B, FIG. 8A illustrates an example in which a single transmitter node 702 transmits data to a single receiver node 704. In examples of DL transmission, the transmitter node 702 may be a BS 170 and the receiver node 704 may be a UE 110. In examples of UL or SL transmission, the transmitter node 702 may be a UE 110 and the receiver node 704 may be a BS 170 or another UE 110. For simplicity, the signaling is illustrated for DL transmissions. However, it should be understood that UL, SL or DL transmissions are all possible as discussed below.

In the example of FIG. 8A, different HPNs are used to indicate different TBs. This may enable the transmitter node 702 greater flexibility in selecting which TBs to use for generating cross-TB check blocks for a retransmission. Transmission of multiple TBs (or more generally data blocks) may be scheduled by a single control signal (e.g., a DCI signal or a SCI signal) or each TB may be scheduled by a respective control signal. In the example shown, the transmission of each TB is scheduled by a respective control signal. As previously mentioned, FIG. 8A illustrates a DL scenario, and the transmitter node 702 may be a BS that transmits the control information in one or more DCI signals. In a UL scenario, where the transmitter node 702 is a UE and the receiver node 704 is a BS, the control information may instead be sent by the receiver node 704 to the transmitter node 702. In yet other scenarios, the control information may be sent by another network entity that is not the transmitter node 702 or the receiver node 704.

In this example, the transmitter node 702 sends control information for a first TB (denoted TB1) in a control signal 802 to the receiver node 704. The control information may provide information about the time-frequency resource block on which a following data transmission is to be received, the modulation and coding scheme used, and other information that may be used by the receiver node 704 to decode the data. In particular, the control information indicates the HPN for the TB to be transmitted (in this case, HPN=1) and the NDI indicates this is a new transmission. The transmitter node 702 then sends an initial transmission 804 of TB1 in Block1. In a similar manner, the transmitter node 702 sends another control signal 806 to schedule the transmission of TB2, where the control information indicates the HPN for TB2 (in this case, HPN=2) and the NDI indicates a new transmission. The transmitter node 702 then performs the initial transmission 808 of TB2. Similarly, the transmitter node 702 sends another control signal 810 to schedule the transmission of TB3, where the control information indicates the HPN for TB3 (in this case, HPN=3) and the NDI indicates a new transmission. The transmitter node 702 then performs the initial transmission 812 of TB3. In some examples, the initial transmission of Block1, Block2 and Block3 may be scheduled by the same control signaling (e.g., a DCI), which indicates the resources used for transmission of all three data blocks (e.g., similar to the examples of FIGS. 7A and 7B).

The receiver node 704 attempts to decode each received TB. In this example, the receiver node 704 successfully decodes TB2 on data block 2, but is unsuccessful at decoding TB1 and TB3 on data block 1 and 3. In this example, the receiver node 704 sends feedback 814 (which may be NACK for Block1 and Block 3, and ACK for Block2) for each data block. The feedback 814 may be multiplexed such that the feedback for all data blocks is sent in one feedback 814. Alternatively, instead of multiplexed feedback, the receiver node 704 may send feedback for each TB individually in separate feedbacks. In other examples, the receiver node 704 may not send feedback (e.g., in the UL scenario, the receiver node 704 may be a BS and feedback may not be required).

The transmitter node 702 determines that a retransmission is required. In this example, cross-TB check blocks are generated using information bits selected from TB1 and TB3. In this example, the transmitter node sends a control signal 816 to schedule the retransmission. As previously noted, in some examples (e.g., UL transmissions) the control information may be sent by the receiver node 704 to the transmitter node 702; in yet other examples the control information may be sent by another network entity. Because each TB has its own HPN, the control information in the control signal 816 indicates the HPN of each TB used to generated the cross-TB check blocks, in this case HPN=1, 3. The NDI indicates that the scheduled transmission is a retransmission. The transmitter node 702 then performs a transmission 818, which is a retransmission using at least one of the cross-TB check blocks generated from TB1 and TB3. In this example, one cross-TB check block is transmitted in the retransmission.

The receiver node 704 uses the cross-TB check block(s) to assist in decoding TB1 and TB3, and may transmit further feedback (not shown) depending on whether the decoding is successful.

FIG. 8B is a flowchart illustrating an example method 850, which may be performed by an apparatus (e.g., the apparatus 200 of FIG. 2) that is a transmitter node. For example, the method 850 may be performed by a BS 170 for DL transmissions, or may be performed by a UE 110 for UL or SL transmissions. The method 850 may be performed for unicast, multicast, groupcast or broadcast transmissions. The method 850 may be used to perform retransmissions using cross-block check blocks (which may be referred to as cross-TB check blocks when the cross-block check blocks are generated using bits selected from across multiple TBs), where each TB has its own HPN. The method 850 may be performed by the transmitter node in the example illustrated by FIG. 8A, for example.

Optionally, at 852, the transmitter node may transmit or receive control information (e.g., depending on DL, UL or SL transmission) for scheduling initial transmissions of multiple TBs. For example, in DL transmission, if the transmitter node is the network entity responsible for scheduling transmissions (e.g., a BS), then the transmitter node may transmit the control information in a DCI to the receiver node (e.g., a UE). In another example, in UL transmission, the transmitter node may be the UE, and the transmitter node may receive control information in a DCI from a network entity (e.g., BS that is the receiver node) instead. In another example, in SL transmission, the transmitter node may be a first UE and the receiver node may be a second UE. For SL transmission, the transmitter node may optionally send control information in a SCI to the receiver node to indicate the transmission resources. If the transmission resources for the SL transmission is scheduled by a network entity (e.g., BS), optionally and additionally, the transmitter node (first UE) may in addition receive a control channel from the network entity in DCI before transmitting the control information.

Initial transmission of the multiple TBs may be scheduled using one control signal, or separate control signals. The control information may include, for example, information about the resource block on which the receiver node may receive data as well as information (e.g., MCS, RV, etc.) to enable the receiver node to decode the received data. In particular, each TB has a respective HPN and the HPN of each TB is indicated in the control information. Additionally, the control information may include an indicator (e.g., NDI) for each TB to indicate that each TB is a new transmission.

At 854, the transmitter node transmits the initial transmissions of the multiple TBs.

As shown in the example of FIG. 8A, steps 852 and 854 may be performed for each TB separately. Alternatively, the control information for multiple TBs may be sent together in one control signal, followed by the initial transmission of the TBs.

If the transmitter node receives feedback (e.g., ACK) indicating decoding was successful for all of the transmitted TBs, the transmission for the current data is complete and the method 850 may end.

Optionally, at 856, the transmitter node may receive feedback from the receiver node indicating that decoding was unsuccessful for at least one of the multiple TBs. The feedback may, for example, be a NACK for each of the TBs that was unsuccessful decoded, a NACK for all TBs, or a NACK indicating decoding is unsuccessful for at least one of the TBs. In some examples, absence of feedback from the receiver node (e.g., absence of ACK) may be interpreted by the transmitter node as indicating that decoding was unsuccessful. In other examples, the transmitter node may be configured to perform a predefined number of retransmissions in the absence of feedback from the receiver node.

In some examples, the transmitter node may not receive any feedback from the receiver node. For example, there may not be any feedback sent by the receiver node in UL communications; instead, the receiver node (e.g., the BS) may itself schedule a retransmission if decoding was unsuccessful. In another example, an ACKless or NACKless feedback scheme may be used, in which case retransmissions may be performed until a predefined maximum number of retransmissions has been reached.

At 858, the transmitter node generates a set of cross-block check blocks using CBs selected from across two or more of the multiple TBs. For example, if the feedback indicated that decoding was unsuccessful for two or more of the TBs, the set of cross-block check blocks may be generated using CBs selected from across those two or more unsuccessfully decoded TBs. In another example, the set of cross-block check blocks may be generated using CBs selected from across all of the multiple TBs that were sent (e.g., if the feedback did not specify which TB was unsuccessfully decoded, or if the transmitter node is configured to generate cross-block check blocks across all TBs). The set of cross-block check blocks is generated combining (e.g., using XOR or encoding) the information bits of the selected CBs to generate the set of cross-block check blocks. In some examples, CB partitioning, as described above, may be used to generate the set of cross-block check blocks.

Optionally, at 860, the transmitter node may transmit or receive control information. Similar to step 852 described previously, the transmitter node may transmit control information or may receive control information, depending on the DL, UL or SL scenario.

The control information includes information to enable the receiver node to decode the retransmission (e.g., MCS, etc.). The control information may include, for example, the time frequency and other resources used for retransmission, the information to identify any partitioning of the CBs (e.g., how many partitions or how many CBs in each partition), any interleaver (e.g., the subblock interleaver) or other information indicating how bits were selected to generate each cross-block check block, and/or information about the encoding used to generate the cross-block check blocks (e.g., code rate, redundancy version, etc.). In particular, the control information for scheduling the retransmission includes the HPN of each of the two or more TBs used to generate the cross-block check blocks. The control information may also include an indicator (e.g., NDI) that indicates a retransmission.

At 862, the transmitter node transmits a retransmission of one or more cross-block check blocks from the generated set of cross-block check blocks. The cross-block check block(s) may be used by the receiver node to assist in decoding of the TBs.

If, following the retransmission at step 862, the transmitter node receives feedback indicating unsuccessful decoding at the receiver node (e.g., receives NACK) or in the absence of feedback indicating successful decoding (e.g., in the absence of ACK), the method 850 may return to step 860 to transmit control information for another retransmission (or may return to step 858 to generate another set of cross-block check blocks). If, following the retransmission at step 862, the transmitter node receives feedback indicating successful decoding (e.g., receives ACK) or the maximum number of retransmission has been reached, the transmission for the current data is complete and the method 850 may end. In some examples, the transmitter node may not receive any feedback from the receiver node (such as in UL communications, or in ACKless or NACKless feedback schemes), as previously described.

FIG. 8C is a flowchart illustrating an example method 880, which may be performed by an apparatus (e.g., the apparatus 200 of FIG. 2) that is a receiver node. For example, the method 880 may be performed by a UE 110 receiving DL transmissions or SL transmissions, or may be performed by a BS 170 receiving UL transmissions. The method 880 may be performed in unicast, multicast, groupcast or broadcast scenarios. The method 880 may be used to receive retransmissions using cross-block check blocks (which may be referred to as cross-TB check blocks when the cross-block check blocks are generated using bits selected from across multiple TBs), where each TB has its own HPN. The method 880 may be performed by the receiver node in the example illustrated by FIG. 8A, for example.

Optionally, at 882, the receiver node may transmit or receive control information (e.g., depending on DL, UL or SL transmission). For example, in DL transmission, the receiver node may be a UE and the transmitter node may be a BS, in which case the receiver node may receive the control information in a DCI from the transmitter node. In another example, in UL transmission, the receiver node may be a BS and the transmitter node may be a UE, in which case the receiver node may transmit control information to the transmitter node in a DCI. In another example, in SL transmission, the transmitter node may be a first UE and the receiver node may be a second UE, in which case the receiver node may receive the control information in a SCI from the transmitter node.

The control information may include, for example, information about the resource block on which the receiver node may receive data as well as information (e.g., MCS, RV, etc.) to enable the receiver node to decode the received data. In particular, each TB has a respective HPN and the HPN of each TB is indicated in the control information. Additionally, the control information may include an indicator (e.g., NDI) for each TB to indicate that each TB is a new transmission.

At 884, the receiver node receives initial transmissions of the multiple TBs.

As shown in the example of FIG. 8A, steps 882 and 884 may be performed for each TB separately. Alternatively, the control information for multiple TBs may be received together in one control signal, followed by the initial transmission of the TBs.

At 886, the receiver node performs a decoding operation (also referred to as a decoding attempt) to decode the TBs.

If decoding of all the TBs is successful, the receiver node may send feedback (e.g., ACK) to the transmitter node to indicate successful decoding. In some examples, the receiver node may not send feedback when decoding is successful and the absence of feedback may indicate successful decoding. In some examples, if the receiver node is responsible for scheduling transmissions (e.g., if the receiver node is the BS), no feedback may be required. If decoding is successful, reception of the current data is complete and the method 880 may end.

Optionally, if decoding of at least one TB is unsuccessful, at 888, the receiver node may transmit feedback (e.g., NACK) indicating unsuccessful decoding. The feedback may be specific to each TB, for example to indicate which of the initially transmitted multiple TBs was successfully decoded and which were unsuccessfully decoded. In other examples, the feedback may be non-specific, for example a NACK may indicate unsuccessful decoding of at least one TB of the multiple TBs, without indicating which TB was unsuccessfully decoded. In some examples, absence of feedback from the receiver node may indicate unsuccessful decoding and step 888 may be omitted. In some examples, the receiver node may be configured to not send any feedback regardless of whether decoding was successful or not. In some examples, such as examples where the receiver node is responsible for scheduling transmissions (e.g., the receiver node is the BS), the receiver node may not need to send any feedback.

Optionally, at 890, the receiver node may transmit or receive control information. Similar to step 882 described previously, the receiver node may transmit control information or may receive control information, depending on the DL, UL or SL scenario.

The control information may include information to enable the receiver node to decode the retransmission (e.g., MCS, etc.) and to use the retransmission to assist in decoding the TBs. In particular, the control information includes the HPN of each of the two or more TBs that were used to generate the cross-block check blocks. The control information may also include an indicator (e.g., NDI) that indicates a retransmission.

At 892, the receiver node receives a retransmission of cross-block check blocks that were generated using CBs selected from across two or more of the multiple TBs that were initially transmitted.

At 894, the receiver node uses the received cross-block check blocks to assist in decoding of the unsuccessfully decoded TBs. If decoding is still unsuccessful, this may be indicated in feedback (e.g., NACK) to the transmitter node at optional step 888 or absence of feedback may indicate unsuccessful decoding. If all data blocks are successfully decoded, the receiver node may transmit feedback (e.g., ACK) to the transmitter node or absence of feedback may indicate successful decoding. In some examples, such as in UL communications, no feedback may be required. If decoding is successful or the maximum number of retransmissions has been reached, reception of the current data is complete and the method 880 may end.

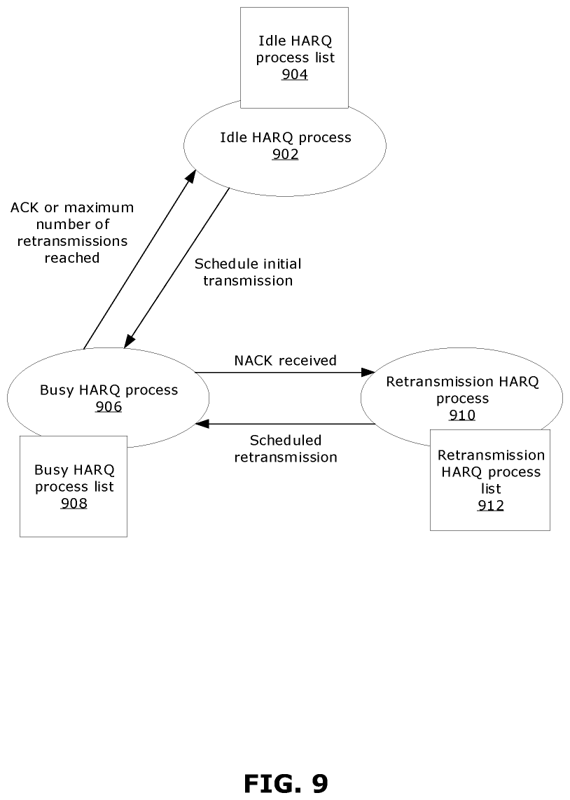

Some examples of how to manage multiple HARQ processes are now described. To assist in understanding this discussion, reference is first made to FIG. 9.

FIG. 9 illustrates a typical three state process for HARQ process management of multiple HARQ processes.

Generally, a HARQ process with a given HPN starts in idle HARQ process state 902. In the idle HARQ process state 902, an idle HARQ process list 904 is created that is indexed by HPN and that includes all HARQ processes that are currently in the idle HARQ process. When an initial transmission is scheduled (e.g., by a BS), the initial transmission is typically scheduled with a HARQ process and a corresponding HPN from the idle HARQ process list 904 (since the HPN from the idle HARQ process list 904 is not currently in use by any existing transmissions). When an initial transmission is scheduled for a given HPN, the state for that given HPN transitions to the busy HARQ process state 906. A HARQ process is removed from the front of the idle HARQ process list 904 to a busy HARQ process list 908. This is to prevent the same HARQ process to be scheduled again before receiving a feedback. When a NACK feedback is received for that HPN, the state transitions to the retransmission HARQ process state 910 such that the HARQ process can be scheduled (e.g., by the BS) for retransmission. The HARQ process is moved from the busy HARQ process list 908 to be added to a retransmission HARQ process list 912. When a BS schedules a transmission for a UE and the UE has a HARQ process in the retransmission HARQ process list 912, the BS typically schedules the retransmission using the HARQ process taken from the retransmission HARQ process list 912. When a retransmission is scheduled for that HARQ process, the HARQ process is moved from the retransmission HARQ process list 912 to the busy HARQ process list 908 again. This is to prevent the HARQ process that is already being scheduled for a retransmission be scheduled again before a HARQ feedback is received. From the busy HARQ process state 906, if an ACK is received for a HARQ process in the busy HARQ process list 908 or if the maximum number of retransmission (or maximum retransmission time) has been reached for the HARQ process, the HARQ process is removed from the busy HARQ process list 908 and placed back on the idle HARQ process list 904. When the HARQ process is placed back on the idle HARQ process list 904, the HARQ process buffer will be released and the HPN is made available for a new HARQ process.

This HARQ process management may be adapted for retransmissions performed using cross-TB check blocks generated from multiple TBs, as disclosed herein. A retransmission performed using cross-TB check blocks generated from multiple TBs is considered to be a retransmission for each of the multiple TBs. If each TB is indicated by a respective HPN (e.g., as in the example of FIG. 8A), this means each TB corresponds to a respective HARQ process. Feedback for multiple TBs (multiple ACKs and/or NACKs) may be multiplexed. Alternatively, a single ACK or NACK feedback may represent feedback for multiple TBs. If a NACK is received for multiple TBs, the HARQ processes associated with the HPNs of the multiple TBs are all moved to the retransmission HARQ process list 912. When a retransmission is scheduled for the multiple TBs, the corresponding HARQ processes for the associated HPNs are all moved to the busy HARQ process list 908. When the retransmission is performed, the retransmission count (i.e., a count of the number of retransmissions that have been performed) is increased for each of the HARQ processes associated with the HPNs. When the retransmission count reaches the maximum retransmission number (or ACK is received) for one of the HARQ processes, the corresponding one HARQ process is moved from the busy HARQ process list 908 to the idle HARQ process list 904, the associated HARQ process buffer is released and the associated HPN is made available for a new HARQ process.

The maximum retransmission number may be also adapted to new values in examples where multiple HARQ processes is used for a single retransmission (e.g., in the example of FIG. 8A). For example, if each retransmission can have a maximum of two HARQ processes, the maximum retransmission number may be adapted by multiplying by two since each retransmission is used for two HARQ processes. Alternatively, the number of retransmissions for each HARQ process may be only multiplied by 1.5 when two HARQ process may be used for a single retransmission. Other ways of adapting the maximum retransmission number may be possible.

The scheduling of HARQ processes may also be adapted for retransmissions performed using cross-TB check blocks generated from multiple TBs, as disclosed herein. Conventionally, for DL transmissions, a BS schedules a retransmission HARQ process before scheduling a new transmission for the same UE. For a retransmission using cross-TB check blocks that are generated from multiple TBs (where each TB has an associated HARQ process), the BS may prefer to use multiple HARQ processes to schedule the retransmission associated with multiple TBs. However, in some cases there may be only one HARQ process available on the retransmission HARQ process list and a retransmission may need to be scheduled for multiple HARQ processes, then the BS would need to wait for another HARQ process to become available on the retransmission HARQ process list before scheduling the retransmission of cross-TB check blocks. This may introduce unwanted latency in the transmissions. The present disclosure provides a time window-based scheduling that may be used instead.

A countdown timer may be assigned to each HARQ process identified by a respective HPN when the HARQ process is placed on the retransmission HARQ process list. The timer may serve as a maximum amount of delay for a retransmission of a TB or HARQ process to be scheduled. The delay may be measured from the start of the time when the TB or HARQ process is available for a retransmission to the time it is actually scheduled for a retransmission. For example, the countdown timer may start at a count of 10 or a count of 20. After each time slot, the timer may be reduced by one. When a retransmission is to be scheduled and there is only one HARQ process on the retransmission HARQ process list and the timer for that one HARQ process is greater than zero, the BS may wait for another HARQ process to be available on the retransmission HARQ process list. Otherwise, if the time for that one HARQ process has expired (i.e., the timer has reached zero), the BS may schedule the retransmission using the single HARQ process. In this way, scheduling of the retransmission will not be delayed for an excessive amount of time.

The above-discussed techniques for managing HARQ processes and scheduling retransmission using HARQ processes may be suitable for any of the examples disclosed herein. The above-discussed techniques for managing HARQ processes and scheduling retransmission using HARQ processes may be suitable for any scenario where retransmission for multiple HARQ process is supported, without being limited to retransmissions using cross-TB check blocks as disclosed herein.

In various examples, the present disclosure describes a CB partitioning technique for generating cross-block check blocks, in which a set of cross-block check blocks is generated from only CBs belonging to selected partitions of two or more data blocks. The disclosed CB partitioning technique may help to reduce the coding complexity, compared to cross-block check blocks generated from across all CBs of two or more data blocks. Using the disclosed CB partitioning technique may be useful for reducing the resources (e.g., bandwidth, processing power, etc.) required for a retransmission, and at the same time may still provide sufficient diversity gain for satisfactory performance and reliability.

The present disclosure also describes examples of a retransmission scheme in which cross-TB check blocks are generated using CBs selected from across two or more TBs. Multiple TBs may be indicated using a common HPN or each TB may have its own HPN. Using a common HPN for multiple TBs may be relatively simple to implement, with relatively simple control signaling and HARQ process management. Using different HPNs for different TBs may provide greater flexibility in selecting different TBs to combine for generating cross-TB check blocks. Using different HPNs for different TBs may enable generation of cross-TB check blocks during retransmission time without predefining or knowing beforehand, when performing the initial transmission, which TBs can be potentially combined.

Example techniques for managing multiple HARQ processes and scheduling retransmission HARQ processes have also been disclosed, which may be useful for retransmissions using cross-TB check blocks, where each TB has its own HPN.

It should be understood that examples of the present disclosure may be embodied as a method, an apparatus, a non-transitory computer readable medium, a processing module, a chipset, a system chip or a computer program, among others. An apparatus may include a transmitting module configured to carry out transmitting steps described above and a receiving module configured to carry out receiving steps described above. An apparatus may include a processing module, processor or processing unit configured to control or cause the apparatus to carry out examples disclosed herein.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method comprising:
transmitting, to a receiver node, an initial transmission of a first data block having a first plurality of code blocks, and another initial transmission of a second data block having another plurality of code blocks; and
transmitting a retransmission to the receiver node, the retransmission including at least one cross-block check block from a first set of cross-block check blocks generated using a first partition of code blocks from the first data block and a first partition of code blocks from the second data block, the retransmission further including at least one cross-block check block from a second set of cross-block check blocks generated using a second partition of code blocks from the first data block and a second partition of code blocks from the second data block.

2. The method of claim 1, wherein each of the first data block and the second data block is partitioned into two or more respective partitions, each partition of the two or more respective partitions having an equal or approximately equal number of code blocks.

3. The method of claim 2, wherein a respective set of cross-block check blocks of the first set of cross-block check blocks and the second set of cross-block check blocks is generated by:
selecting, from each of the first data block and the second data block, a respective partition of the two or more respective partitions, and
combining code blocks belonging to selected respective partitions.

4. The method of claim 1, further comprising:
transmitting another retransmission, the another retransmission including at least one different cross-block check block from the first set of cross-block check blocks and further including at least one different cross-block check block from the second set of cross-block check blocks.

5. The method of claim 1, wherein the first data block and the second data block are respectively a first transport block and a second transport block, a first code block group and a second code block group, or a first packet and a second packet.

6. The method of claim 1, further comprising:
transmitting or receiving control information for the retransmission, the control information including information about partitioning of code blocks in each of the first data block and the second data block.

7. A method comprising:
receiving, from a transmitter node, an initial transmission of a first data block having a first plurality of code blocks, and another initial transmission of a second data block having another plurality of code blocks; and
receiving a retransmission from the transmitter node, the retransmission including at least one cross-block check block from a first set of cross-block check blocks generated using a first partition of code blocks from the first data block and a first partition of code blocks from the second data block, the retransmission further including at least one cross-block check block from a second set of cross-block check blocks generated using a second partition of code blocks from the first data block and a second partition of code blocks from the second data block.

8. The method of claim 7, further comprising:
performing joint decoding of the first data block and the second data block together with the at least one cross-block check block from the first set of cross-block check blocks and the at least one cross-block check block from the second set of cross-block check blocks received from the retransmission.

9. The method of claim 7, wherein the first data block and the second data block are respectively a first transport block and a second transport block, a first code block group and a second code block group, or a first packet and a second packet.

10. The method of claim 7, further comprising:
transmitting or receiving control information for the retransmission, the control information including information about partitioning of code blocks in each of the first data block and the second data block.

11. An apparatus comprising:
at least one processor; and
memory coupled to the at least one processor and storing instructions that, when executed by the at least one processor, cause the apparatus to perform operations including:
transmitting, to a receiver node, an initial transmission of a first data block having a first plurality of code blocks, and another initial transmission of a second data block having another plurality of code blocks; and
transmitting a retransmission to the receiver node, the retransmission including at least one cross-block check block from a first set of cross-block check blocks generated using a first partition of code blocks from the first data block and a first partition of code blocks from the second data block, the retransmission further including at least one cross-block check block from a second set of cross-block check blocks generated using a second partition of code blocks from the first data block and a second partition of code blocks from the second data block.

12. The apparatus of claim 11, wherein each of the first data block and the second data block is partitioned into two or more respective partitions, each partition of the two or more respective partitions having an equal or approximately equal number of code blocks.

13. The apparatus of claim 12, wherein a respective set of cross-block check blocks of the first set of cross-block check blocks and the second set of cross-block check blocks is generated by:
selecting, from each of the first data block and the second data block, a respective partition of the two or more respective partitions, and
combining code blocks belonging to selected respective partitions.

14. The apparatus of claim 11, wherein the operations further include:
transmitting another retransmission, the another retransmission including at least one different cross-block check block from the first set of cross-block check blocks and further including at least one different cross-block check block from the second set of cross-block check blocks.

15. The apparatus of claim 11, wherein the first data block and the second data block are respectively a first transport block and a second transport block, a first code block group and a second code block group, or a first packet and a second packet.

16. The apparatus of claim 11, wherein the operations further include:
transmitting or receiving control information for the retransmission, the control information including information about partitioning of code blocks in each of the first data block and the second data block.

17. An apparatus comprising:
at least one processor; and
memory coupled to the at least one processor and storing instructions that, when executed by the at least one processor, cause the apparatus to perform operations including:
receiving, from a transmitter node, an initial transmission of a first data block having a first plurality of code blocks, and another initial transmission of a second data block having another plurality of code blocks; and
receiving a retransmission from the transmitter node, the retransmission including at least one cross-block check block from a first set of cross-block check blocks generated using a first partition of code blocks from the first data block and a first partition of code blocks from the second data block, the retransmission further including at least one cross-block check block from a second set of cross-block check blocks generated using a second partition of code blocks from the first data block and a second partition of code blocks from the second data block.

18. The apparatus of claim 17, wherein the operations further include:
performing joint decoding of the first data block and the second data block together with the at least one cross-block check block from the first set of cross-block check blocks and the at least one cross-block check block from the second set of cross-block check blocks received from the retransmission.

19. The apparatus of claim 17, wherein the first data block and the second data block are respectively a first transport block and a second transport block, a first code block group and a second code block group, or a first packet and a second packet.

20. The apparatus of claim 17, wherein the operations further include:
transmitting or receiving control information for the retransmission, the control information including information about partitioning of code blocks in each of the first data block and the second data block.
